(19) United States
(12) Patent Application Publication
(10) Pub. No.: US 2005/0100204 A1
(43) Pub. Date: May 12, 2005

(54) Method and apparatus for detecting fluorescent particles contained in a substrate

(75) Inventors: Robert S. Afzal, Providence, RI (US); Christopher A. Schera, East Providence, RI (US); Don Oliver, Wrentham, MA (US)

Correspondence Address: HARRINGTON & SMITH, LLP, 4 RESEARCH DRIVE, SHELTON, CT, 06484-6212, US

(73) Assignee: Spectra Systems Corporation

(21) Appl. No.: 10/703,043

(22) Filed: Nov. 6, 2003

(51) Int. Cl. G06K 9/00; G06K 9/46

(52) U.S. Cl. 382/135; 382/165; 382/190

(57) ABSTRACT

Disclosed herein are methods and apparatus for authentication of various substrates, including paper based substrates such as currency. Techniques are disclosed for use of security features to generate security codes. The security codes are deciphered with apparatus including a color recognition sub-system that provides for verification of authenticity of the substrate containing the security features.

### FIELD OF THE INVENTION

These teachings relate to apparatus and methods for authentication of documents and similar substrates.

### BACKGROUND OF THE INVENTION

It is well known that valuable items such as negotiable instruments and art work are susceptible to theft and counterfeiting. The advancement of color copier technology has made it fairly easy to create a color copy of any document, including currency, using commonly available equipment. In an effort to stem widespread counterfeiting of currency many countries, including the United States, now include a watermark, a security fiber, or both, in their paper based currency. These security features give the receiver a means to verify a particular note's authenticity. The security fiber is embedded in the paper on which the money is printed, and may include a human readable (albeit small) description of the currency imprinted on its surface. Other features may be embedded for authentication purposes. For example, aside from fibers, it is known to utilize planchets and particles to authenticate items. These types of authentication mechanisms may be color based. That is, the security features may exhibit a characteristic color, they may diffract light, or they may fluoresce when subjected to an excitation. For example, these mechanisms may fluoresce under infrared (IR), visible (VIS), or ultraviolet (UV) radiation.

One problem with the use of sophisticated techniques for the protection of valuable items having such security features is the ability to rapidly, reliably and/or remotely authenticate the items. Consider one aspect involving color detection techniques and apparatus.

Techniques and apparatus for color assessment encompass many schemes and instruments. Typically, the standardization of color data between devices calls for use of a color classification algorithm to achieve equivalence between devices. A number of algorithms are known and used. For example, two commonly used color space models are the CIE L,a,b color standard produced by the international standards organization “Commission International de l'Eclairage or International Commission on Illumination,” and the HUNTER LAB™ L*a*b model, produced by Hunter Labs of Reston Va.

In regard to an instrument, many factors enter into performing accurate measurements of color. Included are instrument design, detector limitations, color algorithms, lighting characteristics, and surface characteristics among others. Generally speaking, there are two main types of instruments that are used for measuring the color of surfaces. These are calorimeters and reflectance spectrophotometers. Colorimeters are typically simpler instruments than spectrophotometers.

Colorimeters measure tri-stimulus values, which serve as inputs to various color models, more directly than spectrophotometers. Generally, a calorimeter operates using three broadband filters that are associated with the three primary colors. Typically, a colorimeter measures the light reflected from a target through each of the three filters. Consequently, typical calorimeters only measure reflectance at the three wavelengths associated with the three filters. Although colorimeters do not provide reflectance data for many band of wavelengths, they are sometimes considered preferable to spectrophotometers because of their low cost of manufacture and portability. One example of a colorimeter is contained in U.S. Pat. No. 6,157,454 entitled “Miniature Colorimeter.”

The calorimeter disclosed in U.S. Pat. No. 6,157,454 generates, from a single color measurement, three color data points representing the reflectance of a spot measured at the wavelengths of the three primary colors. The system makes measurements against, or in close proximity to, the surface of the object to be measured. This system, typical of colorimeters, does not provide users with an ability to make assessments of multiple colors in one measurement.

The spectrophotometer is used to produce more accurate assessments of color than those that are produced by a calorimeter. In general, a spectrophotometer uses a specific light source to illuminate the specimen being measured. The light reflected by the object passes to a grating that breaks it into the spectrum. The spectrum falls onto a diode array that measures the amount of light at each wavelength, or range of wavelengths. The spectral data is then sent to a processor where it is combined with data table values for the selected color scale (herein algorithm or model) to produce the coefficients that describe the perceived color. The spectrophotometer is calibrated using a target whose reflectance at each wavelength is known, as compared to a perfect, diffuse reflecting surface. Once calibrated, a user proceeds with color measurement. Certain factors, such as the instrument and sample geometry, as well as surface finish, can play significant roles in the refinement of color measurements when using a spectrophotometer.

One example of a portable spectrophotometer is described by U.S. Pat. No. 6,346,984 entitled “Portable Scanning Spectrophotometer.” This patent discloses providing movement and control of a sample during analysis. The unit includes a base and an upper assembly supported on the base for floating movement. A planar media guide is located on the underside of the upper assembly and surrounds the spectral engine to engage the sample and reduce flexing and bowing of the sample.

Some problems with some existing authentication systems include the incorporation of specialized apparatus, such as sequentially energized light sources to create multiple images. Reference may be had to U.S. Pat. No. 6,269,169 “Secure Document Reader and Method Therefor,” issued Jul. 31, 2001 to Funk et al. Funk et al. disclose apparatus and a method for reading documents, such as identity documents, including passports, and documents of value, to obtain and verify information recorded thereon, and to read and/or detect security information thereon to determine if such documents are counterfeit or have been altered.

Reference may also be had to U.S. Pat. No. 5,418,855 “Authentication System and Method,” issued May 23, 1995 to Liang et al. This patent discloses a system for authentication of articles, wherein articles which have been marked with substances that fluoresce are tested. U.S. Pat. No. 5,608,225 “Fluorescent Detecting Apparatus and Method,” issued Mar. 4, 1997 to Kamimura et al., also discloses use of a fluorescent emission from a marking.

As examples of other identification or authentication systems, reference may be had to U.S. Pat. No. 6,373,965 “Apparatus and Methods for Authentication Using Partially Fluorescent Graphic Images and OCR Characters,” issued Apr. 16, 2002 to Liang; and, U.S. Pat. No. 3,513,320 “Article Identification System Detecting Plurality of Colors Disposed on Article,” issued May 19, 1970 to Weldon. A further device is disclosed in an IBM Technical Disclosure Bulletin “Sequential-Readout Identification Tag” by Dickerson and Williams, Volume 17, No. 3, August 1974. This bulletin discloses a device intended for use as a tag usable for non-contact scanning according to wavelength.

Many of the foregoing instruments are limited to color detection and measurement. Typically, these instruments do not provide other capabilities necessary or desirable for the assessment of other aspects of security features. For example, many of these instruments are not equipped to determine a color and a shape of a security feature.

What is needed are methods and apparatus for making accurate assessments of the authenticity of at least one of the color, shape and size of security features included in a valuable item or substrate. For example, what is needed is a device that can reliably recognize narrow bands of wavelengths appearing in the ultraviolet (UV), visible (VIS), or infrared (IR) regions of the electromagnetic spectrum, and make rapid determinations regarding the security features. In addition, it would be useful to measure a plurality of security features, having diverse aspects such as multiple colors, sizes and shapes, and analyze combinations thereof.

### SUMMARY OF THE INVENTION

These teachings are directed to a system for assuring security of documents and other similar substrate. Aspects of the invention disclosed herein include: use of security features with a substrate and a system for recognition of the security features.

The unique security features (or “particles”) are characterized by, among other things: having substantially no body color, or apparent body color, so as to be substantially “invisible” under visible light; precise and uniform appearance at various sizes; and, application techniques that provide for uniform loading and control over large areas.

The system includes a hand-held device collects an image of a substrate offered for authentication, and performs a number of steps to authenticate the substrate. These steps may include, without limitation: the de-mosaic and decimation of the image to produce a set of composite color pixels; calculation of background gray level; detection of the security features; analysis of the properties of the security feature; and, logic processing to ascertain the presence of a security code derived from the security features.

The system thus provides for an integrated technique to assure the authentication of documents and other valuable items.

One aspect of the teachings herein provides a method for authentication of a substrate that includes: generating a color image of the substrate that contains pixels; identifying at least one region of authentically colored pixels by comparing the color of at least a portion of the pixels to a predetermined color in a first comparison test; determining at least one geometric aspect for the at least one region by counting pixels along a perimeter of the at least one region; comparing the at least one geometric aspect of the at least one region to at least one predetermined geometric value in a second comparison test; and authenticating the substrate if the first comparison test and the second comparison test are successful.

Another aspect of the teachings herein are a system for authentication of a substrate that includes: a source of authentication data comprising authentic color information and geometric aspect information, the authentication data derived from at least one color image of at least one authentic substrate comprising at least one set of security features; an imaging sub-system for producing a color image for authentication of the substrate; and, a processor coupled to the source of authentication data and coupled to the imaging sub-system, the processor adapted for comparing the color image to the authentication data and determining the authenticity of the substrate.

A further aspect of the teachings herein includes a method for providing calibration data for a system for authenticating a substrate that includes: selecting at least one authentic substrate having at least one set of security features; generating a color image of the at least one authentic substrate; analyzing the color image to determine color data for each set of security features and storing the color data as calibration data; and, analyzing the color image to determine geometric aspect data by counting pixels about the perimeter of individual security features in each set of security features and storing the geometric aspect data as calibration data.

Another aspect of the teachings herein includes a computer program stored on computer readable media, the computer program providing instructions for operation of a device adapted for authentication of a substrate by: generating a color image of the substrate, the color image comprising pixels; identifying at least one region of authentically colored pixels by comparing the color of at least a portion of the pixels to a predetermined color in a first comparison test; determining at least one geometric aspect for the at least one region by counting pixels along a perimeter of the at least one region; comparing the at least one geometric aspect of the at least one region to at least one predetermined geometric value in a second comparison test; and, authenticating the substrate if the first comparison test and the second comparison test are successful.

It should be recognized that some of the foregoing steps may be omitted or adapted as a result of modifications to the techniques disclosed in the embodiment presented herein.

For example, use of a sensor array other than the one disclosed herein may give rise to the adaptation of the foregoing color recognition steps.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is a block diagram showing the major sub-components of a hand-held, portable, device for obtaining color measurement and analysis;

FIG. 2 is an elevational view of the apparatus of FIG. 1;

FIG. 3 depicts color response of a sensor array;

FIG. 4 is a graph depicting one example of a transmission spectrum for an ultraviolet (UV) filter;

FIG. 5 depicts one embodiment of spectral response for a sensor array where UV and infrared (IR) filters are used;

FIG. 6 depicts spectra for two illumination sources;

FIG. 7 is an illustration of the HUNTER LAB™ color space;

FIG. 8 is a simplified block diagram of the hand-held, portable device having a wireless link to a remote data processor, such as one that may be used to track color measurements;

FIG. 9 is an example of a Bayer mosaic pattern of color filters for overlying the sensor, and

FIG. 9A is an illustration of the effect of combining a group of sixteen pixels to effectively yield an composite color pixel;

FIG. 10 is an illustration of an image of a document submitted for authentication, and FIG. 10A is an exploded view of a portion of the image wherein security features are shown;

FIG. 11 is an illustration of a color cone;

FIG. 12 is an illustration of two valid color areas;

FIG. 13 is a flow chart depicting aspects of the process for authentication;

FIG. 14 is a graph depicting a comparison of device performance for various color security features;

FIG. 15 is an illustration of a document standard;

FIG. 16 depicts a histogram of various hand sheets containing green security particles;

FIG. 17 depicts a linear fit of green average counts and loading densities;

FIG. 18 depicts a histogram of various hand sheets containing blue security particles;

FIG. 19 depicts a linear fit of blue average counts and loading densities;

FIG. 20 depicts a histogram of various hand sheets containing yellow security particles;

FIG. 21 depicts a linear fit of yellow average counts and loading densities;

FIG. 22 depicts a histogram of various hand sheets containing red security particles;

FIG. 23 depicts a linear fit of red average counts and loading densities;

FIG. 24 is a graph depicting counts versus distance with best focus at each distance;

FIG. 25 is a graph depicting counts versus distance with a fixed-focus distance of 8 cm;

FIG. 26 depicts readout of GBY security particles without any overprint;

FIG. 27 depicts readout of GBY security particles with 30% overprint of cyan ink;

FIG. 28 depicts readout of GBY security particles with a 30% overprint of magenta ink;

FIG. 29 depicts green and blue particles and the respective valid color areas in the GB plane with a 30% yellow overprint;

FIG. 30 is a graph depicting a series of 100 successive images collected with the device wherein the placement of the subject was held constant;

FIG. 31 is a histogram presentation of the data in FIG. 30;

FIG. 32 is a graph depicting a series of 100 successive images collected with the device wherein the placement of the subject was not held constant;

FIG. 33 is a histogram presentation of the data in FIG. 32;

FIG. 34 depicts performance of various flash illumination units; and,

FIG. 35 depicts a normalized spectral response for PolyStar™ security particles.

### DETAILED DESCRIPTION OF THE INVENTION

These teachings are directed to a system for assuring security of documents and other similar substrate. Disclosed herein are the use of security features which provide document security, and a system for recognition of the security features and the subsequent authentication of the document. One skilled in the art will recognize that the teachings herein may be useful in authentication schemes for a variety of instruments including personal identification, currency, notes, original works, and others. Although discussed herein in terms of a “document”, this is a non-limiting embodiment of a substrate, and considered only to be illustrative of the invention disclosed herein.

The document security system includes, but is not limited to, use of security particles, which include certain pigments, as one embodiment of a security feature. The security particles may have enhanced security value, as described herein. The security particles can be incorporated into documents through various techniques. An appropriately designed and configured detection system provides for recognition of the security particles, or other security features, and may perform logical decision making processes in order to provide authentication information.

Security Particles

As disclosed herein, security particles provide for the authentication and therefore security of a document. However, many other types of security features may be used, alone, or in combination with the security particles. Some of these other security features include, without limitation: threads, ribbons, discs, planchets, fluorescent printing and fibers. The security particles disclosed herein are therefore but one embodiment of a security feature for a document. Although the disclosure herein generally refers to the use of security particles, one skilled in the art will recognize that the teachings regarding security particles are illustrative and exemplary, and are not limiting of this invention.

The security particles referred to herein are generally characterized by, among other things: having a general lack of body color, or an “invisible” appearance under visible light; precise and uniform size at mean diameters ranging from about 50 to about 200 microns; application techniques that provide for uniform loading and control over large areas (in one embodiment, as high as 3,000 particles per square decimeter); a significant range of colors that extend beyond more commonly available UV colors such as blue. For example, the additional security pigment colors include red and yellow. These security particles are generally contrasting with a background, thus many aspects of a distribution of security particles may be used for security purposes.

As used herein, “no body color” generally means that each security feature is substantially white, but can fluoresce with other colors—and that the security particle is capable of substantially blending with other colors, such as the colors in a surrounding substrate. A security particle having a “body color” is characterized as a security particle that has, at least in part, a color under white light illumination.

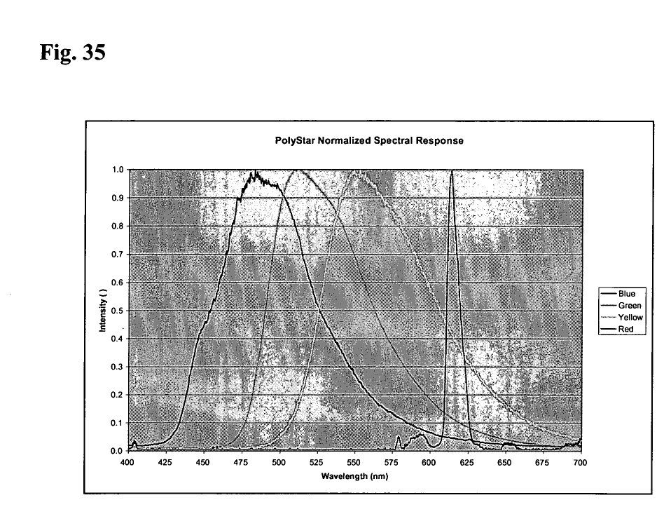

One embodiment of security particles includes security particles that are formed of materials such as plastic powders containing a small percentage of any one of several fluorescent pigments. The security particles may be manufactured in several fluorescent colors and in several particle size ranges above 50 microns up to about 200 microns. Related structures may be formed and based on identical or similar materials. One example of related structures is powdered particles that may include a variety of coatings and/or ink formulations. These related structures are generally characterized by having particle size ranges below 50 microns. These smaller structures may be used for other purposes, such as, in a non-limiting example, to modify the general appearance (e.g., color) of a background to the security particles. One presently preferred security particle that meets these various criteria is known as PolyStar™, and is available from Spectra Systems of Providence R.I. FIG. 35 depicts a normalized spectral response for the PolyStar™ security particles. In FIG. 35, the security particles exhibit peaks with half-widths of about 70 nm. The red security particles have a noticeably more narrow peak than the yellow, green or blue.

Security particles are particularly well suited for coding products which would naturally attract and/or retain at least some of the particles. Non-limiting examples of retentive materials include textiles and porous materials. By applying various particle combinations on the product, or on a substrate attached to the product, a code can be created and associated with the product. Although electrostatic attraction may cause these particles to be adequately retained, enhanced binding can be achieved using appropriate materials, for example, a mesh incorporated into the product or binding agents such as starches or hair spray types of products.

In other embodiments, the security particles are included within the material used to form the substrate. For example, in one embodiment, the security particles are disbursed within a matrix, such as pulp, for the generation of security paper. However, it should be noted that the foregoing embodiments are not limiting of techniques for the formation of security particles, or security features, as referred to herein.

Additional coding combinations can be made by incorporating fluorescence emission or body color into the security particle. With UV excitation, for example, at least five unique wavelength categories or frequency ranges can be created. Combining these five different wavelength categories, ((2^{F})−1) combinations are possible. In this function, F represents the number of wavelengths from which to choose. That is, with five wavelengths, (2⁵−1)=31 combinations may be realized. Where other characteristics are included, a greater number of combinations are possible. For example, including one other characteristic provides for ((2^{F})^{D}−1) combinations, where D additionally represents the number of options in the second characteristic. That is, with five wavelengths and three diameters, ((2⁵)³−1)=32,767 combinations are possible.

In addition, the loading factors of various security particles can be employed as a further variable. For example, there may be a set of security particles having two members, the first comprised of red particles of 50 micron diameter and the second comprised of red (or green, or blue, or yellow) particles having an 80 micron diameter. The first particles may be present with a loading factor of 20 per square centimeter, while the second particles may be present with a loading factor of 40 particles per square centimeter. By counting the numbers of particles per unit area of each type, one may determine the information encoded by the selected security particles. For example, a paper document having this particular set of security particles is identified as a first type of negotiable instrument, while another paper document having a different set of security particles (e.g., red particles of 25 micron diameter and 80 micron diameter with loading factors of 50 per square centimeter and 100 per square centimeter, respectively) is identified as a second type of negotiable security. Furthermore, one may verify the authenticity of the negotiable security by verifying that the expected set of security particles are actually present with the expected size ranges and loading factors.

Further examples of coding techniques are disclosed in the International Application PCT/US00/42065, filed under the PCT and published as International Publication Number WO 01/37207 A1; and the corresponding U.S. patent application Ser. No. 09/708,273 entitled “Authentication and Coding by Size, Shape and Fluorescence,” filed Nov. 8, 2000, Lawandy. The disclosures of these applications are incorporated by reference herein in their entirety.

Detection of the security particles is performed using an appropriately configured device, such as the non-limiting example of the VERICAM™ produced by Spectra Systems Corporation of Providence R.I. Aspects of detection equipment, and operation thereof, are now described.

Hand-Held Authentication Device

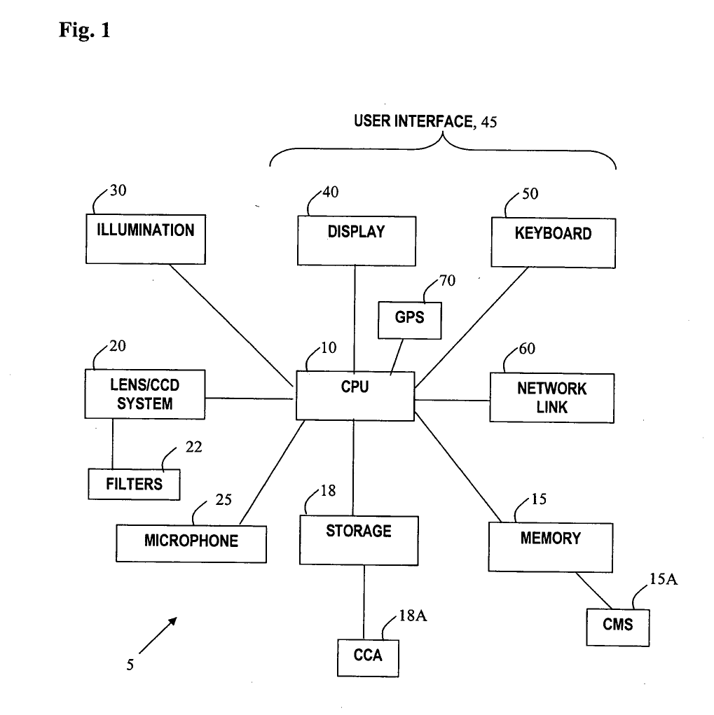

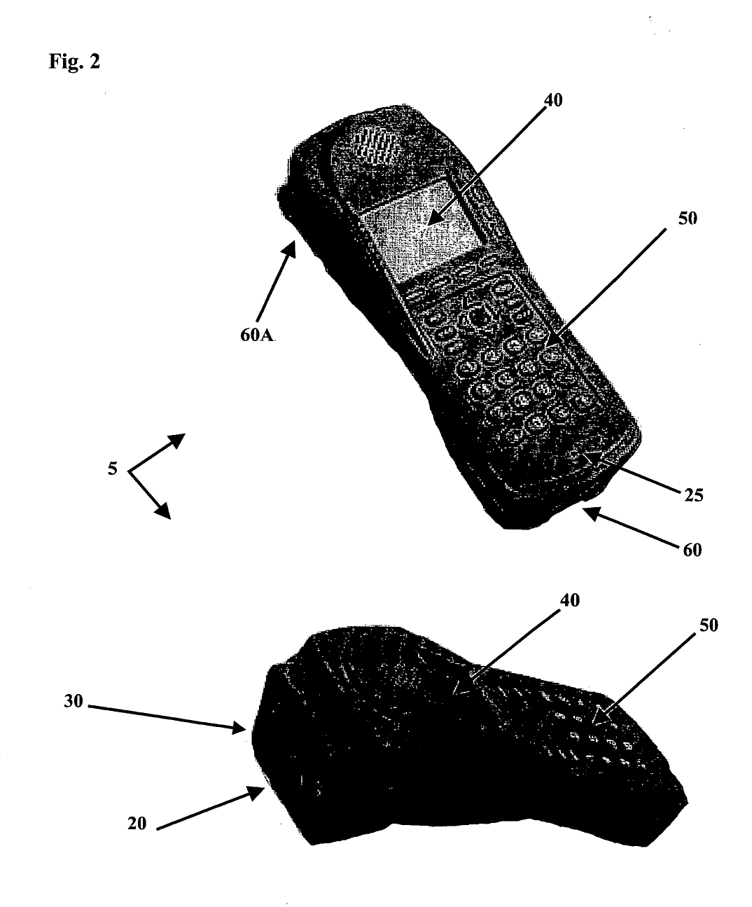

Referring to FIG. 1 and FIG. 2, the hand-held apparatus for security feature authentication, or device 5, includes a CPU 10, such as an embedded microprocessor, an internal read/write memory 15 and optional, preferably non-volatile, mass storage 18. Also included is a digital camera lens/CCD system 20 (which may include a filter 22, or a plurality of filters 22), at least one illumination source 30 and a user interface 45 that includes, for example, a display (LCD) 40 and a keypad or keyboard 50. A touch screen, a color display, or any other suitable interface may be used as well, or in place of other interface components. The illumination source 30 can be a variable intensity source controlled by an operator, and it can also include a flash source, such as a xenon flash. The illumination source 30 may contain an adapter that provides for interchangeability of illumination sources 30. However, in some embodiments, the illumination source 30 may not be necessary depending on the ambient illumination conditions.

The lens/CCD system 20 and illumination source 30 can be located on a surface opposite that of the display and keyboard 50, enabling the operator to view the image being captured on the display 40, and to manipulate the keys of the keyboard 50 such as to adjust the color measurement process, initiate the operation of the color measurement software (CMS) 15A stored in the memory 15 or storage 18, and perform other functions, such as initiating a transfer of data to a remote location via a wireless network link 60 having, for an RF embodiment, an antenna 60A. The lens/CCD system 20 includes a digital camera of adequate resolution (e.g., 1.45 mega pixels or greater), with appropriate support circuitry providing auto-focus and other typically found features. The lens/CCD system 20 may include any photosensitive imaging sensor that is considered appropriate, such as, in a non-limiting example, a gray-scale CCD or a CMOS array. In preferred embodiments, the device 5 does not include gamma correction, automatic gain adjustment, or otherwise include other color or light compensating features.

In an exemplary embodiment of a lens/CCD system 20 for practice of the teachings herein, the following components may be included. A chip CCD sensor, having features such as model ICX205AK, which is available from Sony Corporation, may be included. This chip includes a ½-inch optical interline CCD solid-state image sensor with a square pixel array and 1.45M effective pixels. The chip is capable of progressive scan for independent output of all pixel signals within approximately 1/7.5 second. A frame rate readout mode supports approximately 30 frames per second. The chip includes an electronic shutter with variable charge-storage time that provides for generation of a full-frame still image without a mechanical shutter. High resolution and high color precision are achieved through the use of R, G, B primary color mosaic filters 22. Further, high sensitivity and low dark current are achieved through the adoption of HAD (Hole-Accumulation Diode) sensors.

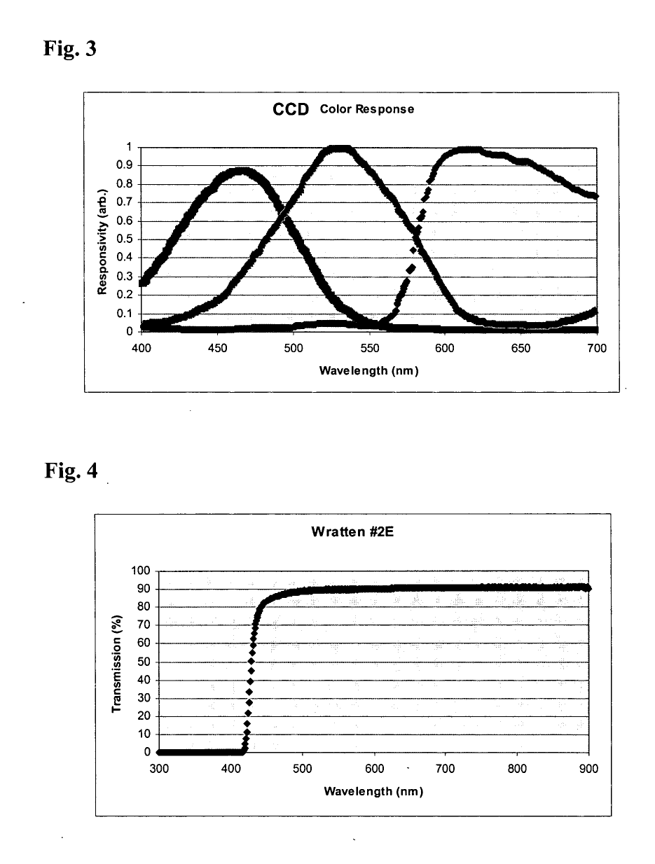

FIG. 3 depicts color response of one chip that is suited for practice of this invention.

Preferably, the CCD/lens system 20 includes, without limitation, a 2 element telecentric, achromatic system; a multi-position filter wheel; provides for incremental steps from f/3 to f/24 (with a default aperture setting of f/5.82 for use with the teachings herein); a shutter speed ranging from 1/2000 second to 2 seconds; a focus range 1.25″ to infinity (with a default focus of about 8 cm for use with the teachings herein); a Wratten™ 2-E filter (of Eastman Kodak Corporation, Rochester, N.Y.) to pass only UV light; a full-motion video capability to aid in positioning and attaining best focus; and an IR filter to sharpen the red long edge.

FIG. 4 depicts one example of a transmission spectrum for a Wratten™ 2-E filter.

Preferably, the illumination system 30 includes a replaceable high power xenon flash lamp module which plugs into the device 5. In a preferred embodiment, the life expectancy of the flash module is approximately 50,000 flash cycles. Various filters 22 can be interchanged in the lens/CCD system 20 to account for different types of illumination 30. Examples of types of illumination include, without limitation: standard white, which may be useful for capturing images and scanning standard monochromatic barcodes, deep blue, which may be useful for certain authentication systems, and ultraviolet, which is preferred for decoding invisible barcodes, fluorescing marking systems, and for use with this invention for obtaining images of fluorescent security features such as particles.

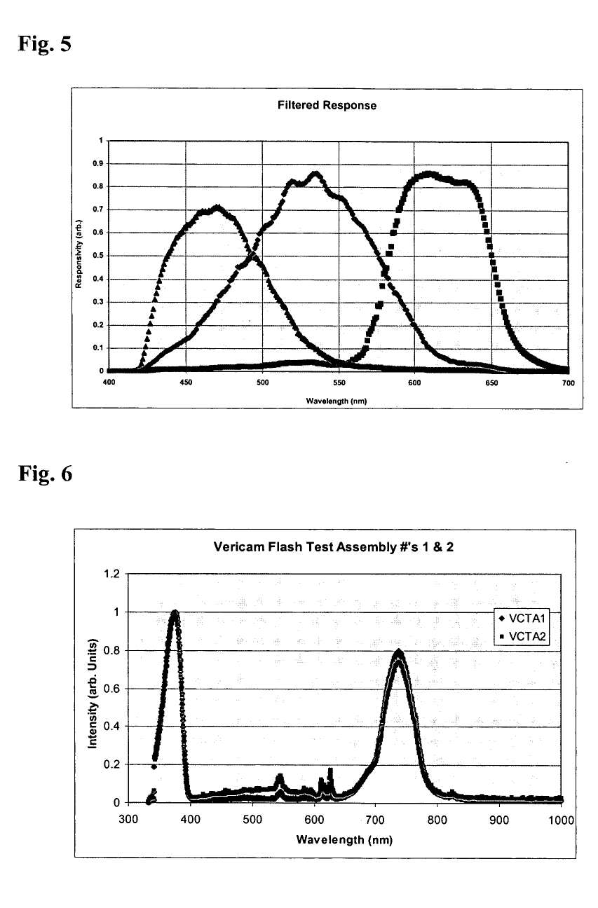

FIG. 5 depicts one embodiment of a system response spectrum for an illumination with UV and IR filters in place. FIG. 6 depicts typical UV flash spectra for two separate illumination sources 30.

The device 5 may be battery powered, or powered by an external power supply. Preferably, the device 5 is sized so that it can be readily manipulated with one hand by the operator, in much the same manner that a digital camera or a wireless communications device can be manipulated by a user. An optional microphone 25 can be provided for use with the embodiment that includes a wireless transceiver.

In accordance with a preferred embodiment, the memory 15, or more preferably, the non-volatile storage 18, includes one or more data sets where each data set represents a color space model, or CCA 18A. Each CCA 18A, also referred to herein as a “color classification algorithm,” or “algorithm,” includes information for derivation of color coordinates. For example, in one embodiment, the CCA 18A represents the HUNTER LAB™ Color Space, which is a product of Hunter Associates Laboratory of Reston, Va.

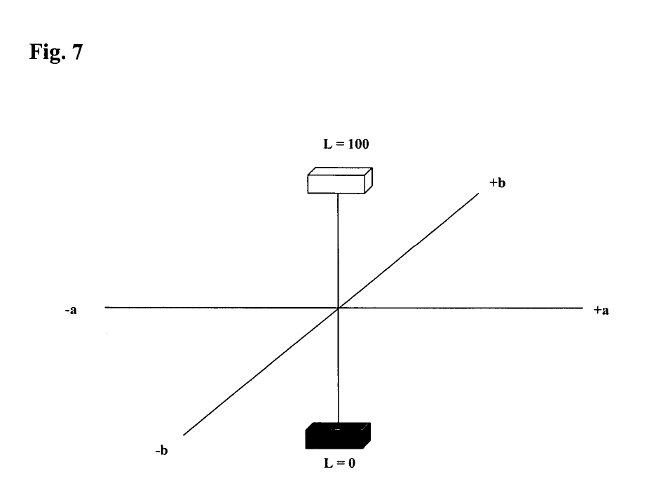

The HUNTER LAB™ Color Space is a three dimensional rectangular color space based upon the opponent-colors theory. The three coordinates (L, a, b) represent aspects of any single color within a spectrum of colors. “L” represents a lightness axis, where 0 is black and 100 is white; “a” represents a red-green axis, where positive values are red, and negative values are green; and, “b” represents a blue-yellow axis, where positive values are yellow, and negative values are blue. Input observation data is fed into certain expressions to derive each color coordinate. In this exemplary embodiment, these expressions are: L=100(Y/Yₙ)^{1/2}; a=Kₐ(X/Xₙ−Y/Yₙ)/(Y/Yₙ)^{1/2}; and, b=K_{b}(Y/Yₙ−Z/Zₙ)/(Y/Yₙ)^{1/2}; where Kₐ and K_{b} are system coefficients. The input observation data is described by the tri-stimulus variables X, Y and Z. In this embodiment of a CCA 18A, the respective expressions for L, a, and b with coefficients Kₐ and K_{b} are included in the CCA 18A, as well as instructions for the derivation of the X, Y and Z values from image data. In other embodiments, information required to enable use of other color schemes, such as but not limited to the CIE 2° or CIE 10° scheme is assembled into a CCA 18A. An illustration of the HUNTER LAB™ Color Space is shown in FIG. 7.

In FIG. 7, two color samples are shown. The colors are at the extrema of the L axis, and appear in black (L=0) and white (L=100). As color space models are known, it is sufficient to limit further comment to pointing out that one skilled in the art will recognize that this system therefore provides for developing relationships between a palette of colors, and is therefore useful to the device 5 described herein.

Preferably, the color scheme selected for use is chosen, at least in part, in consideration of the capabilities of the device 5. For example, the color space is selected to maximize sensitivity or discrimination of color for a given lens/CCD system 20. More specifically, and only as an example, in some embodiments, the lens/CCD system is outfitted with an array of red, green and blue color filters 22 (such as in a Bayer Mosaic pattern, discussed further herein). Preferably, a color space is selected that optimizes aspects of operation of the device 5, in light of the array of filters 22.

The CMS 15A coordinates the function of device 5 components, including use of CCA 18A. In one embodiment, the CCA 18A may require illumination, whereas another CCA 18A may make use of ambient or an external source of light. The CMS 15A operates to provide coordination between the sensor array 20, the illumination source 30, the CCA 18A, and other components as necessary to complete execution of a color measurement.

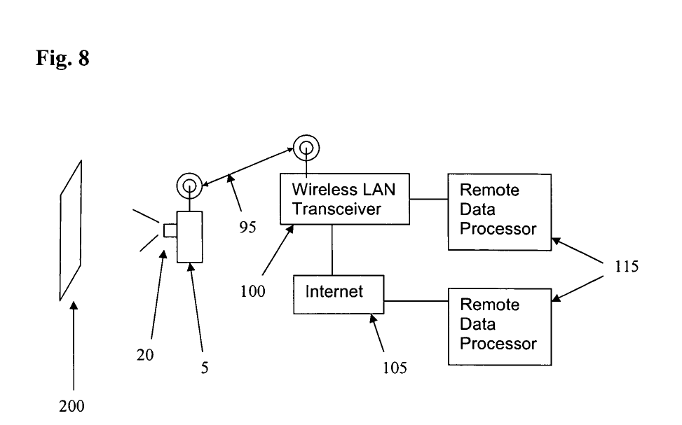

Referring to FIG. 8, the device 5 may execute a given CCA 18A based upon the stored CCA 18A either alone, or in cooperation with one or more remote data processors 115. As shown in FIG. 8, a wireless link 95 can exist between device 5 and a wireless local area network (LAN) transceiver 100 that can be coupled directly to a first remote data processor 115A, and may be coupled indirectly to a second remote data processor 115B through a wide area network (WAN), such as the Internet 105. Either one or both of the remote data processors 115 can be a source of CCA 18A that are transferred into the device 5 using the wireless link 95 and associated components. Data representing one or more CCA 18A may be inputted to the device 5 using the wireless link 95, or the data can be loaded using a wired connection, such as through a USB port, or by inserting a preprogrammed memory card or media. That is, in one embodiment the storage 18 may be removable from and installable within the device 5.

The CCA 18A can thus be updated as new and/or improved color classification algorithms are developed, or as user needs dictate. The CCA 18A may be broadcast to a large number of devices 5 for updating them en masse while they are in use in the field.

In another embodiment, one or more of the remote data processors 115 could be associated with a law enforcement agency using color management for authentication of currency or immigration documents. The result of a color measurement operation executed by the CMS 15A may be transmitted from the apparatus using the wireless link 95, either alone or in conjunction with raw or processed color data captured from a color target 200.

In use, an operator of the device 5 holds the device 5 so as to obtain a measurement from the color target 200, and is enabled to readily change the location of the device 5 relative to the color target 200. This provides for rapidly making multiple measurements of a single color target 200, or multiple color targets 200.

The CMS 15A may account for various factors, including but not limited to, device 5 characteristics and/or lighting conditions, while evaluating data input from the lens/CCD system 20.

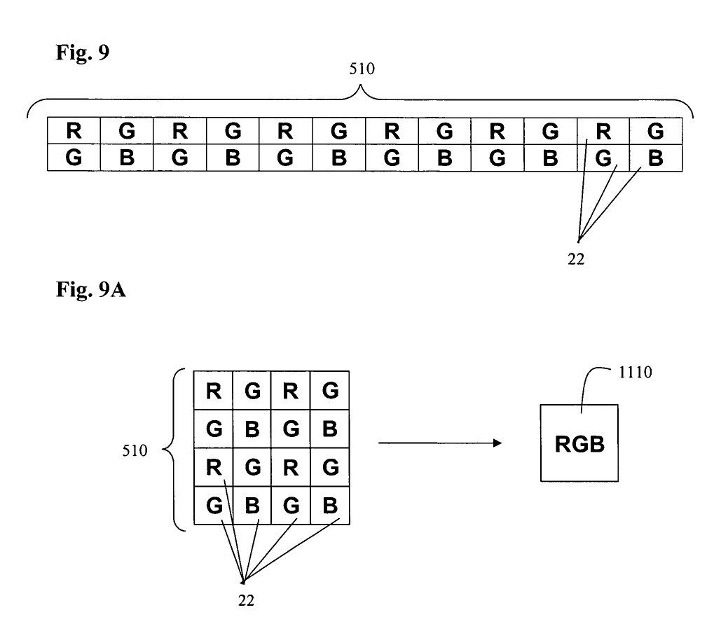

The device 5 contains, in one non-limiting example, an image sensor 20 that is 1360 pixels wide by 1024 pixels high. In one embodiment, the image sensor 20 is a gray-level sensor overlaid with a Bayer mosaic pattern of color filters 22, such as those found in inexpensive consumer NTSC color video cameras. An example of a Bayer pattern mosaic 510 is given in FIG. 9.

The Bayer mosaic pattern 510 of FIG. 9 gives color information in a lower bandwidth signal than the gray scale information. In this embodiment there is twice as much green bandwidth as red or blue. This design resulted from the bandwidth allocation of the NTSC color signal, which contains more green than red or blue, owing to the higher sensitivity of the human vision system to green. In FIG. 9, each of the “G,” “B” and “R” represent one of the green, blue, and red color filters 22, respectively. Therefore, the bayer mosaic pattern 510 is one type of an arrangement of the color filters 22.

Decoding and Authentication

Decoding and authentication of the image proceeds through various steps. Each of these steps may be completed in the order described herein, or some of these may be rearranged to produce an alternate order. In other embodiments, certain steps may be omitted or modified to produce a desired outcome. Therefore, it is considered that the following steps are illustrative of the techniques used for authentication of a document and are not limiting of the invention.

A first step to decoding and authentication involves what is referred to as de-mosaic and decimation. This step permits the device 5 to achieve reduced processing time by using lower image resolution. In one embodiment, the application software 15A reads the raw Bayer image data from the sensor 20 and derives an RGB image by combining groups of sixteen pixels to yield a new image that is decimated by a factor of four in each spatial dimension. This effect is shown in FIG. 9A. In FIG. 9A, a bayer mosaic pattern 510 is arranged in the array of color filters 22. Thus, using this approach, an original 1360×1024 mosaic image is decimated to a 340×256 RGB image, or an image that contains 87,040 composite color pixels 1110. The resulting composite color pixel 1110 generally provides enhanced data for color discrimination. In this example, where green filters 22 are in a 2:1 ratio with red or blue, color levels are set using the following formulas: Red Level=R; Green Level=(G1+G2)/2; and, Blue Level=B.

In some embodiments, only a portion of the image is analyzed using the processes described below, or equivalents thereof. That is, it may be considered that aspects of the security features are robust enough, such that processing speed may be improved by analyzing only a portion of an image, without a coincident loss in the level of security.

As one example, the CMS 15A divides a decimated RGB image into 80 sections, each 34 composite color pixel blocks wide by 32 composite color pixel blocks high. The CMS 15A determines the average gray level for each of the 80 sections. These average gray levels are used as background gray levels to which the gray level of candidate security particles will be compared. Average gray levels may be established for portions of an image or an entire image. In one embodiment, average gray level is determined by for each of the 80 sections by calculating (R level+G level+B level)/3 for each pixel in the section. These average gray levels will be used as background gray levels to which the gray level of candidate particles will be compared.

Once an average gray level determination has been completed, the software scans each pixel block in the image. In one embodiment, the CMS 15A starts at the upper left corner of the image and proceeds top-to-bottom and left-to-right. Pixel scanning examines each pixel block to determine if the gray level for a pixel is above a certain value. In preferred embodiments, the value is a threshold ratio of the gray level of the pixel to the average gray level of a portion of the image, or the entire image. Where the gray level of the composite color pixel 1110 exceeds the average gray level, the composite color pixel 1110 is tested for color.

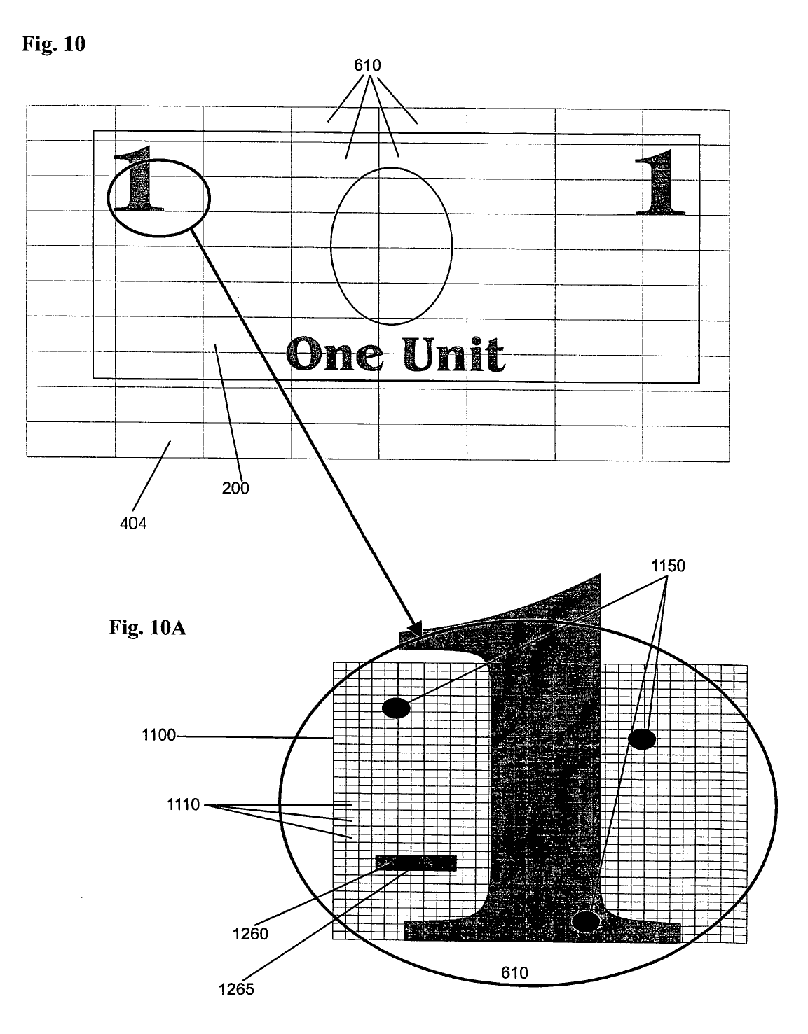

FIG. 10 is an illustration of the processing of an image 404 of a document 200 submitted for authentication, wherein the image 404 has been divided into 80 individual sections 610. One section 610, in the upper left hand corner is further presented as FIG. 10A. FIG. 10A shows the section 610 contains a grid 1100 formed of composite color pixels 1110. The grid 1100 is 34 pixels wide by 32 pixels high. In FIG. 10A, three security particles 1150 are shown.

In one exemplary embodiment of a set up of the device 5, each axis of the selected color space correlates to a color in the bayer mosaic pattern 510. For example, the X axis represents red, the Y axis represents blue, and the Z axis represents green. Accordingly, the bayer mosaic pattern 510 is constructed of color filters 22 that are one of red, blue and green. In this embodiment, the brightness of a given color correlates to distance from the origin in the color space, and increases with distance therefrom.

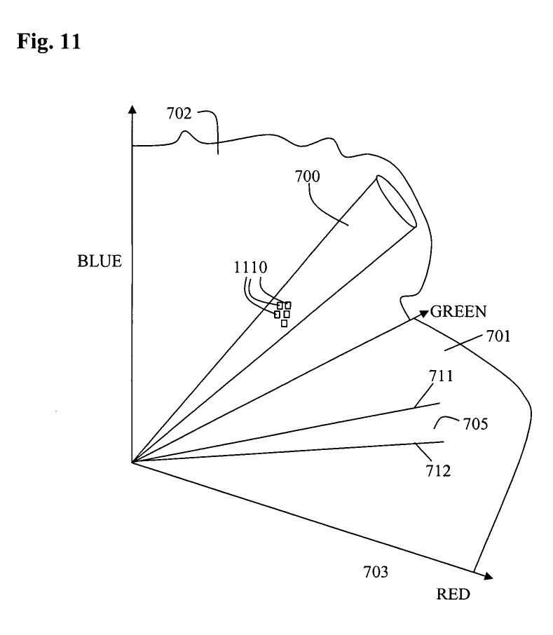

Color testing of a pixel 1110 begins with assigning a set of color space coefficients to the pixel 1110. Once color coordinates for the pixel 1110 are known, the location in the color space of the pixel 1110 is checked for membership in several “color cones.” The color cones are actually sets of color coordinates that are representative of the pigments associated with the security particles 1150 appearing in an authentic document 200, and are described as cones due to their representation within the color space. A color cone 700 is illustrated in FIG. 11.

In other embodiments, the color cone 700 is described by other shapes. For example, in embodiments using color space models having different coordinate systems, the color cone 700 may appear more as a box, or as a cell within a cylinder.

In a preferred embodiment, testing of the membership of the color of the pixel block 1110 within the color cone 700 is completed by comparing pairs of coordinates representing the projection of the color point onto each of the three color planes (RG 701, GB 702, RB 703) with data describing authentic colors.

Consider one example where a measured value for a pixel block 1110 is plotted in colorspace having R, G and B axes, as shown in FIG. 11. Within the colorspace, a color cone 700 defines a set of points that represent valid colors. When the color cone 700 is projected on to the principle planes of the colorspace (RG 701, GB 702, RB 703), the color cone 700 is defined by two lines which define the boundaries 711, 712 of the color cone 700 as a valid color area 705. A valid color area 705 is thus defined in each of the principal planes 701, 702, 703. The lines in each principal plane 701, 702, 703 are described by the equation:
y=mx+β
or,
b=mg+β

The lines have known values for slope m and intercept β in each plane 701, 702, 703. Various methods may be used to determine the slope m and intercept β. In one embodiment, these values are derived empirically, using a predetermined set of data. In another embodiment, a line fit is completed using computational techniques for analysis of the predetermined set of data.

Using this relation, the position of a pixel 1110 in the GB plane 702 is given by (g, b). This position is evaluated against the two line equations that correspond to the boundaries of the valid color area 705. For the upper line, the “g” value for the pixel 1110 is multiplied by the slope (m), and this result is added to the intercept (β). The process is carried out again for the lower line. If the “b” value for the pixel 1110 is both below the upper line's value and above the lower line's value, the color value of the pixel 1110 is determined to reside within the GB 702 projection of the color cone 700. Thus, testing the color of a pixel 1110 in a principal plane 701, 702, 703 involves two multiplications, two additions and one comparison and results in a determination of whether the color of a pixel 1110 is resides within (is a member of) a valid color area 705. In this case, the valid color area 705 is defined by an upper boundary 711 and a lower boundary 712.

Testing the membership of a pixel 1110 is repeated for remaining principal planes 701, 703. Thus, for a three test involving three colors, the foregoing operations are carried out a total of nine times per particle (i.e., 3 color cones×3 principal planes).

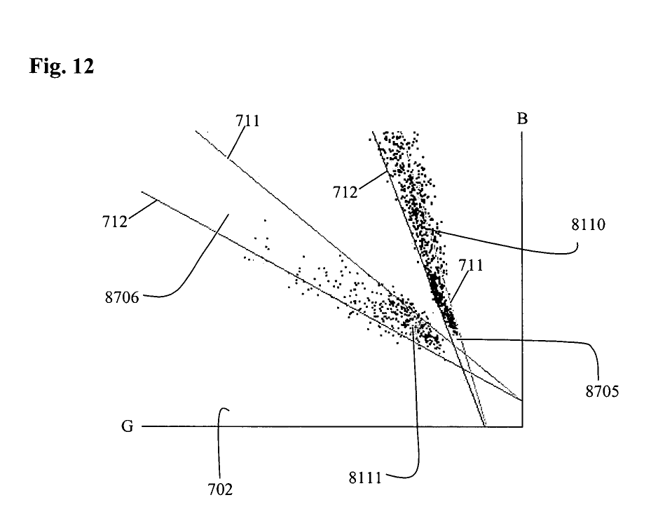

FIG. 12 provides an illustration of two valid color areas 8705, 8706 projected onto the GB plane 702. Each valid color area 8705, 8706 has associated with it, a series of composite color pixels 8110, 8111. As can be seen referring to FIG. 12, some of the pixels 8110, 8111 lie within the respective valid color area 8705, 8706, some of the pixels 8110, 8111 outside of the respective valid color area 8705, 8706. The foregoing calculation therefore determines whether each of the pixels 8110, 8111 is valid or invalid when compared to the respective valid color area 8705, 8706. Accordingly, statistical qualifications can be useful in determination of overall authenticity of a substrate 200. For example, a statistical qualification may include evaluation of error at a specific confidence interval.

In the foregoing embodiment, the color of the pixel 1110 is tested against the valid color areas 8705, 8706 having an upper boundary 711 and a lower boundary 712. However, it is recognized that these boundaries 711, 712 may be uniquely associate with certain color space models. Therefore, it is recognized that other color models may present valid color areas that are defined by other sets of boundaries.

This embodiment of a color determination routine therefore provides for rapid determination of color authenticity for each composite color pixel 1110. Accordingly, the user may be notified whether the color of a pixel 1110 is associated with an authentic pigment color (inside the color cone 700), or with a copy of an authentic pigment color (outside the color cone 700).

Further, in reference to FIG. 12, it can be noted that the valid color areas do not actually intersect with the point of origin in the color space. This is because, in practice, colors may not be “pure” or precisely matched to the device 5 (i.e., the color of the security features may be at least somewhat mismatched with the color filters 22 of the lens/CCD system 20). However, displacement of a valid color area 8705, 8706 from the point of origin in the color space need not perturb the ability to accept or reject a color as described herein. One method to improve the relationship of a valid color area 8705, 8706 in relation to the point of origin, is through calibration of the device 5.

A number of factors can affect how well a device 5 will detect security features within a document. For example, CCD sensitivity and illumination conditions can play a significant role in authenticity determinations. In preferred embodiments, a process called “training,” or “calibration” of the device 5 is completed prior to making authenticity determinations. Training is completed in order to reduce variability between readers 5, improve detection of security features, and to improve counterfeit rejection.

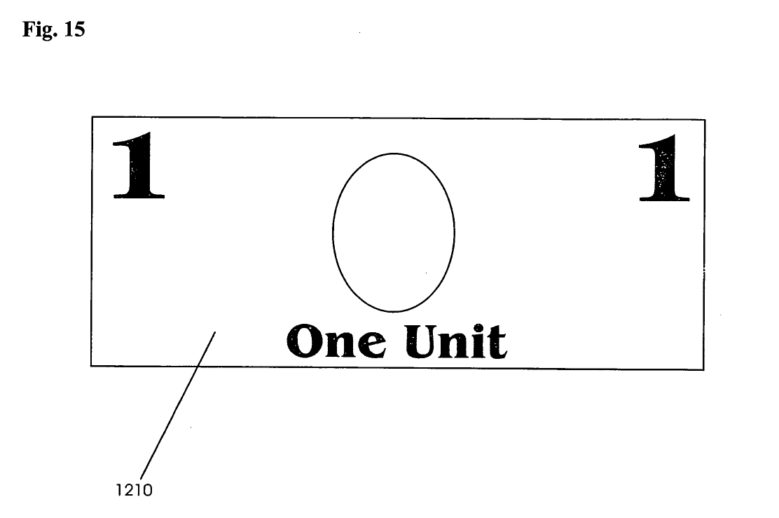

In one embodiment of a training sequence, each device 5 creates its own color cones 700. In order to train a reader 5, a document standard is placed into conditions that will be typical of measurement conditions. That is, the lighting, sensor 20 to target 200 geometry, and other considerations, are as close as possible to operational conditions. One example of a document standard 1210 is shown in FIG. 15. In one embodiment, the document standard 1210 is produced by obtaining an authentic version the substrate (which includes a distribution of security features 1150), when the substrate is newly produced or freshly minted. In other embodiments, the document standard 1210 is taken from a population of worn authentic substrate 200. Multiple standards 1210 may be used, in any appropriate combination of conditions.

Aspects of the document standard 1210 are programmed or downloaded into the device 5. The device 5 then acquires and analyzes at least one image 404 of the standard 1210. The device 5 then generates a variety of calibration coefficients which relate image data to the standard 1210. For example, a device 5 may generate its own color cone information. In other embodiments, the device 5 may generate calibration coefficients that relate image data to authentic size ranges for the security features. In further embodiments, the device 5 may generate calibration coefficients upon completion of an appropriate series of measurements of one or more standards 1210. In these embodiments, the device 5 may further develop calibration coefficients based upon a statistical analysis of device 5 performance characteristics. Further training routines may involve, without limitation, the use of close counterfeit documents 200, and the subsequent analysis of false-positive performance data. Training of the device 5 may be completed through automated and/or manual techniques.

Once a pixel block 1110 has been found that is a valid color for a security particle 1150, the CMS 15A may determine other aspects as appropriate. For example, the CMS 15A may determine geometric aspects, or morphological aspects, of a security feature such as, and not limited to, the shape or size of the candidate particle 1150 producing the valid color. For convenience, such determinations are referred to as “shape determinations” although these aspects are not limited to a shape or size. For example, morphological aspects may include a study of the structure or form of the candidate particle 1150. This may include analysis of the shape and structure of the candidate particle 1150, as distinguished from the material forming the particle 1150. More specifically, such an analysis may consider the thickening of the particle 1150 (from one portion of the particle in relation to another), a thinning of the particle 1150, connected components (which particles 1150 overlap), and other similar analyses.

In one embodiment of a shape determining algorithm, the CMS 15A searches for the left edge of the particle 1150, using gray level thresholds. Once the left edge has been found, the CMS 15A proceeds in a clockwise direction to trace the perimeter of the candidate particle 1150 while counting the number of pixel blocks 1110 traversed. In this exemplary embodiment, if the number of pixel blocks 1110 exceeds a fixed limit, the candidate particle 1150 is rejected. For example, valid security particles 1150 may be considered to have perimeters that range in pixel 1110 counts from six to ten pixels 1110 for a given color. For example, if the CMS 15A encounters a particle 1150 having a valid color, the CMS 15A will trace the perimeter of the candidate particle 1150 by counting contiguous pixels 1110 where an outer edge of the particle 1150 appears. The CMS 15A will total the number of contiguous pixels 1110. If the total count is a number outside of the acceptable range, the particle 1150 is rejected. In this example, particles 1150 that fall within the range of six to ten pixels 1110 are accepted as valid security particles 1150, and counted as an occurrence of acceptable size comparison information. In the embodiment depicted in FIG. 10A, each of the security particles 1150 fall within the range of acceptability, and therefore pass the size comparison test, also referred to as a “perimeter walk test.” Such evaluations may therefore be referred to as “doing a perimeter walk,” or “performing a perimeter walk.” The “perimeter walk” algorithm is particularly useful for small circularly symmetric objects, but other techniques for more complex shapes may be used. For example, connected components analysis, thinning and thickening analyses, and hit-or-miss transforms are among the other morphology determining algorithms that may be employed.

As an example, consider a hit-or-miss transform. Generally, the hit-or-miss transform is a template matching. Consider a black and white image containing thee different sizes of white squares on a black background. The transform is employed as a search technique to find the middle sized square. A template is laid over the image, and used to scan for the exact shape you trying to match, which is the middle size square. Preferably, the template contains a feature sized to match the target portion of the image (middle sized square). When the template feature is completely white, data is entered into a reference index to make a record of that location. As one example, a copy of the image is marked with a dot for each of the middle sized squares. Both the smaller and the larger squares are not entered into the record. That is, the small squares will never fill the template (sized for the middle square) so there will not be a dot. When the template finds the large squares, there will be more that one match where the template is fully white so a series of contiguous dots or a large dot will be the result. The large squares will also then be disqualified.

Other techniques may be employed to compliment the hit-or-miss transform. For example, statistical analyses may be employed to account for the effects of mis-alignment or other problems. Multiple scans may further be employed to increase the versatility of the hit-or miss transform.

Selection of a particular morphology determining algorithm, or combination of algorithms, depends on various factors, such as the nature of the security feature intended for detection. Morphological determining algorithms are also referred to herein as “shape determining algorithms.” However, referring to such an algorithm as a “shape determining” algorithm is not meant to be limiting the algorithm to determination of shape, other features (e.g., size) may be determined by the algorithm.

In preferred embodiments, once a determination has been made that a particle is an authentic security particle 1150 (i.e., at least that that it has a valid color and a valid geometric aspect), the position of the particle within the image 404 is recorded. The CMS 15A then resumes searching for additional particles 1150. Since the position of the security particle 1150 is known, it can be considered that the region of pixels representing the authentic security particle 1150 is essentially “erased” from the image 404, and need not be examined again.

Counting pixels 1110 is one embodiment of a morphological determining algorithm, and is not limiting of the invention disclosed herein. Embodiments of counting pixels 1110 and other morphological (or shape) determining algorithms, may require certain initial conditions. For example, knowledge of the dimensions of the substrate 200 may be required, in order to ascertain dimensions of security features. Alternatively, the geometry of the substrate 200 in relation to the device 5 may be required to provide for derivation of the size of the appearance of the security particles 1150.

Counting pixels may be used in some embodiments of a morphological determining algorithm to ascertain the presence of a certain shape. For example, the morphological determining algorithm may identify that one portion of the perimeter of a security particle 1150 runs substantially parallel to another portion of the perimeter of the security particle 1150, the result being indicative of a fiber 1260 or other elongated structure. Accordingly, it can be considered that executing a morphological determining algorithm provides for determining a “geometric aspect” (or a “morphological aspect”) of the security particle 1150. As counting proceeds along the perimeter, directional data can be incorporated. That is, identification that one aspect of the perimeter of a security particle 1150 (e.g., an edge) bears a certain relation to another aspect of the security particle 1150 (e.g., is parallel to another edge) may make use of a direction indicated by following a portion of the perimeter of the security particle 1150.

FIG. 10A depicts aspects of further embodiments of a perimeter walk. In FIG. 10A a fiber 1260 is shown as a security feature that is in addition to the security particles 1150. As an example of a perimeter walk about the fiber 1260, the CMS 15A traces the perimeter 1265, starting at one end of the fiber. The CMS 15A counts the pixels 1110 as described above, also making record of the direction. That is, the CMS 15A records that the perimeter 1265 extend in a linear direction, about seven pixels 1110 in distance, along at least one side. Accordingly, the CMS 15A determines that the security feature is a fiber 1260, and proceeds with appropriate qualification for authentication.

Preferably, counting pixels 1110 and other morphological determining algorithms are appropriately designed to account for phenomena that may occur in the detection of a given security feature. For example, it is known that edge effects play a role in the detection of very small security features. As used herein, “edge effects” refers to blending, scatter, and other phenomena that may lead to detection problems. Edge effects can be qualified by statistical methods, or combinations which rely on other security features more easily detected for a significant portion of the authentication algorithm, while the security features characterized by having edge effects play a lesser role.

Another verification step may involve code qualification. A number of embodiments of coding are possible. That is, codes may be assembled using mixes of colors, by controlling loading, by controlling size, and/or other aspects of a security particle 1150. As a rudimentary example, one code uses three colors that are a certain mixture of blue, green and yellow. In this embodiment, code verification involves a “count up” approach, where the number of genuine color determinations for each color, such as yellow, is tracked. Once a specific number of positive comparison tests have occurred, the color yellow is certified as being present. The same process is completed for the other colors. Once all colors (blue, green and yellow) are certified as being present, the code is validated and authentication is considered successful.

Further aspects of qualification of the same code structure relate to detection of counterfeit documents 200. For example, finding a number of security features having colors that lie close to, but outside of, a respective color cone may be tracked as well. Should a sufficient number of outlying data points be present, the certain color may be decertified and the user may be informed the document 200 is a suspect document 200.

Two important considerations lie in use of count up algorithms for code qualification. First, the number of genuine counts needed to certify a color is preferably set low enough to pass detection and measurement requirements, while avoiding false-positive detections. Secondly, the loading of substrate 200 with security features 1150 is preferably high enough to statistically exceed random count results, while being acceptable for field use.

Therefore, certain thresholds may be established to provide assurance against false positive detection. For example, a given color code may be rejected in five or more instances of a color code that is near to, but outside of, a color cone. Exemplary color codes include, and are not limited to, BGY, GY, Y, G, BGW, BW, GW, W, GYW, and YW, where B=blue, Y=yellow, W=white, and G=green.

It should be recognized that this is but one embodiment of a code, and the code qualification. Many other embodiments may be realized. For example, coding may consider other features, such as particle 1150 size in association with a color. Coding therefore incorporates or provides for use of logic analysis in the verification process. Therefore, although these examples discuss authentication tests involving a color, these tests may be applied to morphological aspects of the security features as well.

In some embodiments, a device 5 is programmed and trained to identify a single code. In other embodiments, the device 5 may be programmed and trained to recognize a number of codes. This latter embodiment may be particularly useful in situations, such as where the device 5 is used to authenticate multiple denominations of currency 200, each one having a distinct code.

Code recognition is achieved through a logic template that is preprogrammed into software 15A. The logic template may provide AND, OR, and NOR selection based on color, count and size. Using appropriate software 15A, the device 5 provides an ability to recognize various colors and to selectively resolve an outcome. For example, if the device 5 was programmed to evaluate a substrate containing only blue and green, when blue, green and yellow are detected, the result will be rejected, and the user will be notified of a suspect document 200.

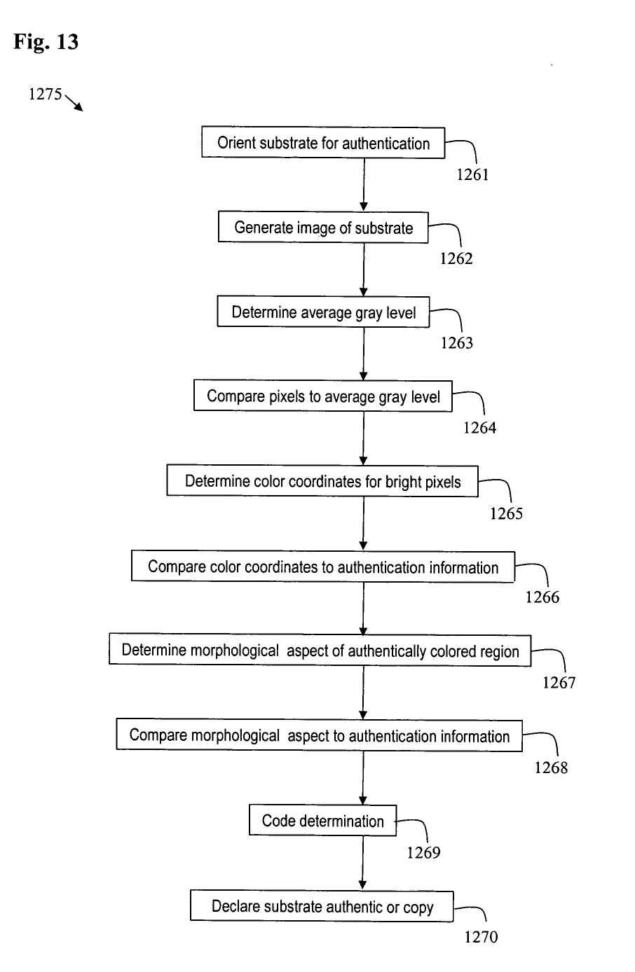

FIG. 13 presents a flow chart 1275 depicting one embodiment of the process disclosed herein for authenticating a substrate 200. In the flow chart 1275, a first step 1261 includes orienting the substrate 200 for authentication. In a second step 1262, an image 404 of the substrate 200 is produced. In a third step 1263, an average gray level is determined. As previously discussed, this average gray level may be for selected portions of the image 404, or over the entire image 404. In a fourth step 1264, the CMS 15A compares the gray level of individual pixels 1110 to the average gray level. In a fifth step 1265, the CMS 15A determines the color coordinates for each bright pixel 1110 identified. In a sixth step, the color coordinates for the bright pixels 1110 are compared to authentication information for determination of whether the color present in the image 404 is an authentic color. In a seventh step 1267, once a authentically colored pixel has been identified, a geometric aspect, such as size or shape, is determined. In a eighth step 1268, the geometric aspect is compared to appropriate authentication information. In a ninth step 1269, the CMS 15A determines the presence of a code. In a tenth step 1270, the CMS 15A declares the substrate 200 as authentic, or a forgery.

One skilled in the art will recognize that the steps in the flow chart 1275 may be rearranged, at least partially, to provide for authentication. For example, the CMS 15A may reject a substrate 200 as a forgery before the determination of geometric aspects. The CMS 15A may operate to “scan” an image 404 so as to produce color coordinates for all security features in a substrate 200, before commencing geometric analysis. In an alternative embodiment, the CMS 15A commences geometric analysis as soon as a authentic color is identified.

Aspects of the process may be adjusted as need be to account for various known conditions, such as the circulation of forgeries having recognizable color coordinates that may be distinguished from an authentic copy 200. In this case, the device 5 may include authentication information that is actually used to authentic one of an authentic version or a copy. In this embodiment, aspects of known forgeries may be included in the authentication information to reduce processing time and/or increase device 5 accuracy.

Further Aspects of the System

In one embodiment, the device 5 is used in a specific relation to the color target 200 in order to perform a color measurement. The specific relation is the same relationship used to train the device 5 to a standard. In another embodiment, the device 5 is used as a hand-held device 5, where a user operates the device 5 following certain guidelines. For example, the guidelines provided may require the user to place a substrate 200 on a flat surface, to hold the device 6 to 8 inches over the substrate 200, and to image the substrate 200 using the illumination source 30.

In one embodiment, the CPU 10 executes CMS 15A that is suitable for combining data from the color target 200, obtained through the lens/CCD system 20, with CCA 18A information, in order to provide the color coordinates of the color target 200.

In another embodiment, the CPU 10 stores the color data generated by the CMS 15A. The data may be stored in a compressed format according to a storage algorithm retrieved from memory 15 or storage 18, as an array corresponding to the CCD architecture, or through another means. The color data may be communicated in real time, or subsequent to the measurement processes, to a remote system for analysis, or in another suitable manner.

It is within the scope of these teachings to include some type of location determining system within the device 5, such as one based on the Global Positioning System (GPS) 70. In this case the location of the device 5, and hence the location of the color target 200, can be transferred to the remote data processor(s) 115.

System Performance

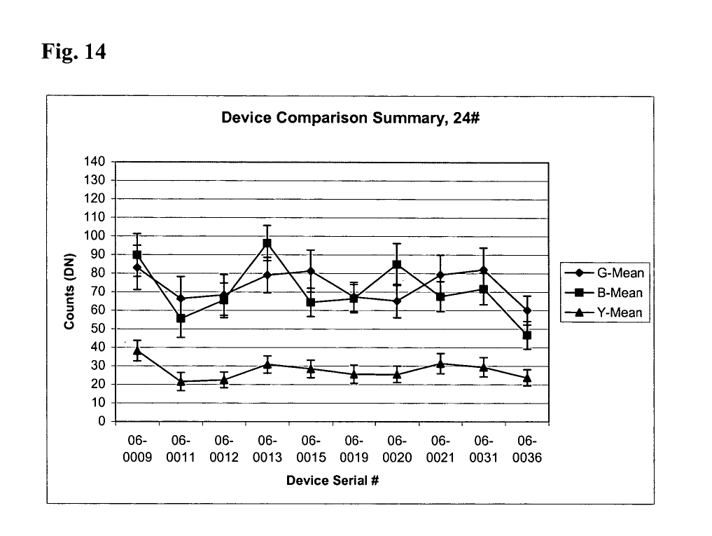

In one examination of device 5 performance, different loadings of security particles 1150 onto 24 pound paper were assembled. This examination considered the stability of variations among a series of devices 5. Results of the examination are depicted in FIG. 14. The data presented show that the device 5 can distinguish between different loading concentrations and configurations. Further data is presented in the following tables.

Device No.:

| | | | | |
|---|---|---|---|---|
| 1 | 2 | 3 | 4 | Grand Avg. |

First Data Set

| | | | | | |
|---|---|---|---|---|---|
| Device Avg. G | 41 | 46 | 47 | 39 | 43 |
| Device Avg. B | 19 | 27 | 31 | 18 | 24 |
| Device Avg. Y | 53 | 69 | 50 | 59 | 58 |

Second Data Set

| | | | | | |
|---|---|---|---|---|---|
| Device Avg. G | 58 | 65 | 66 | 45 | 58 |
| Device Avg. B | 53 | 64 | 63 | 33 | 53 |
| Device Avg. Y | 19 | 28 | 38 | 16 | 25 |

The above data represents two different loading configurations and concentrations. By placing upper and lower bounds on each color, a range of acceptability is created. In some embodiments, examining the variability in each device 5 and across multiple devices 5 would provide information for setting the bounds.

A “do not exceed number” or other bright-line test may be used. For example, such a test may be used to initiate other statistical tests, such as the verification of relations, size, color, or other aspects of the security features, alone or in a group.

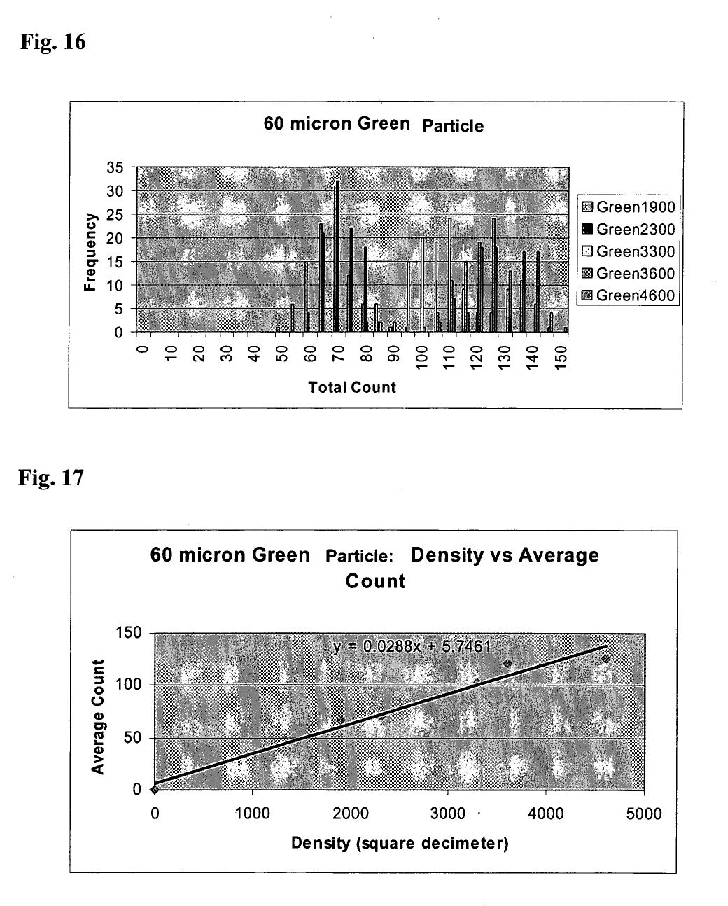

Further testing was performed, where detection of four colors (blue, green, yellow and red) were analyzed individually. Various hand-sheets of paper were made with different concentrations of the security particles 1150. Loadings ranged from less than 2,000 particles per square decimeter to over 6,000 particles per square decimeter. For these tests, the device 5 was mounted on a platform at a fixed height, while the hand sheets were moved between imaging. Results are provided in FIGS. 16-22.

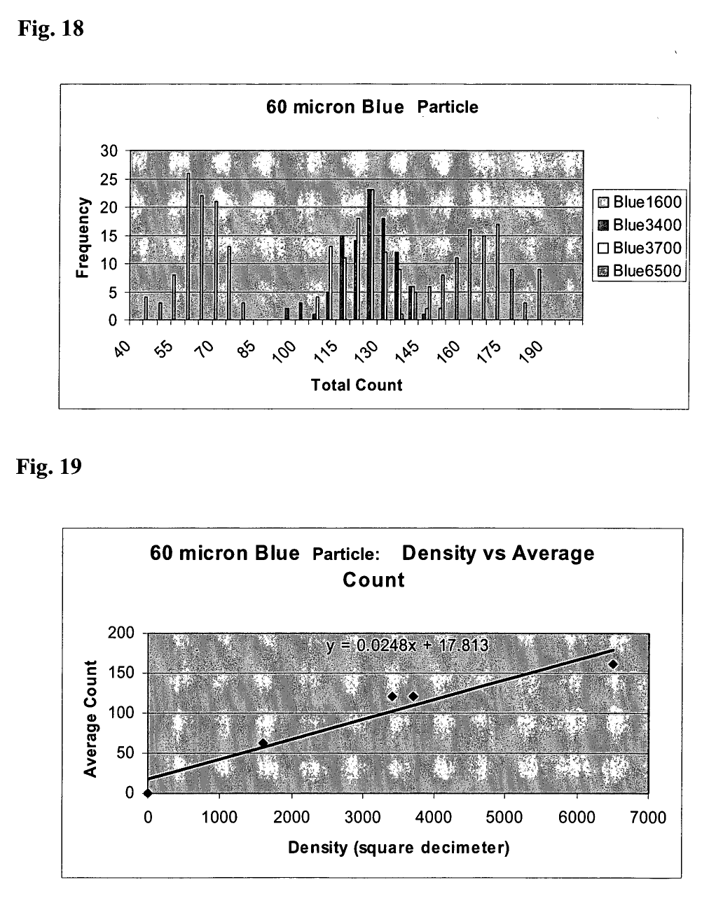

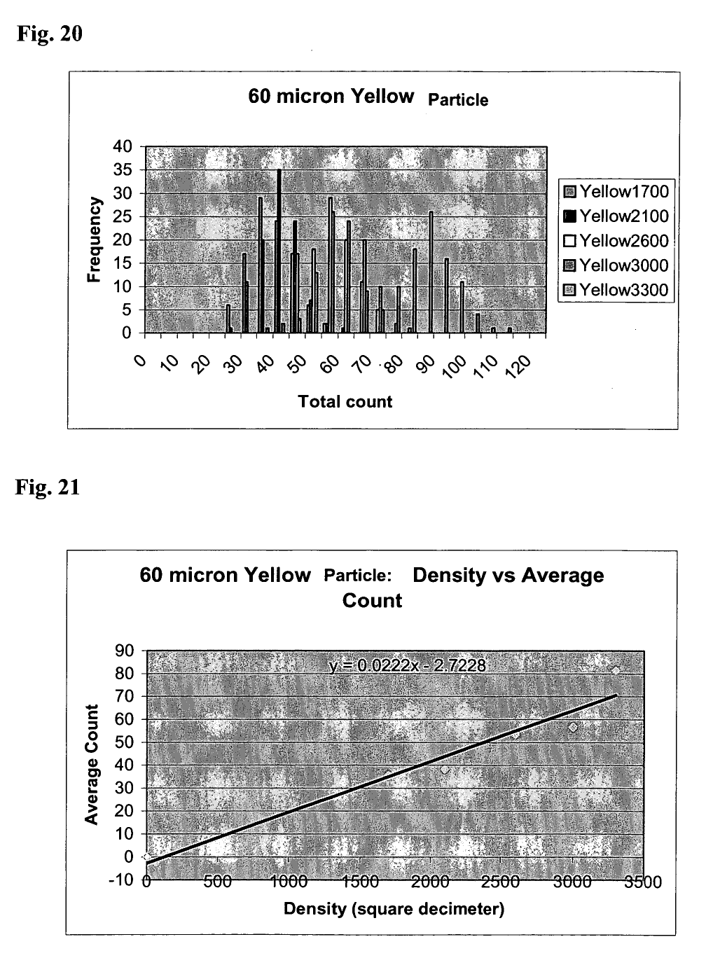

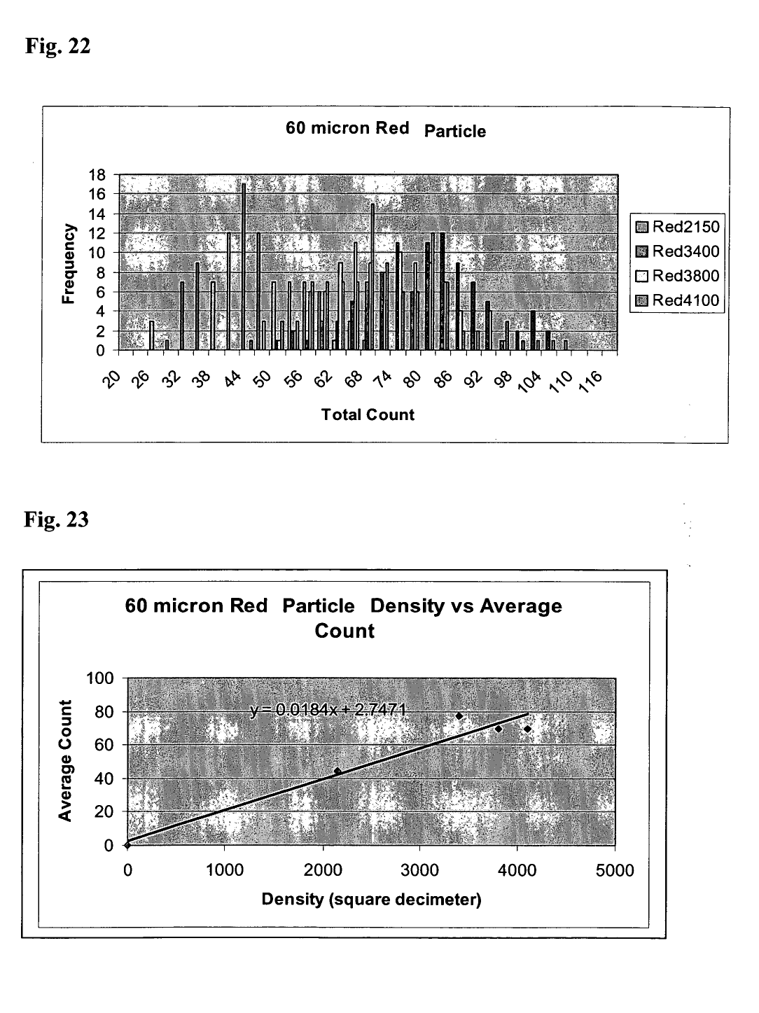

FIG. 16 depicts a histogram of various hand sheets containing green security particles; and FIG. 17 depicts a linear fit of green average counts and loading densities. FIG. 18 depicts a histogram of various hand sheets containing blue security particles; and FIG. 19 depicts a linear fit of blue average counts and loading densities. FIG. 20 depicts a histogram of various hand sheets containing yellow security particles; and FIG. 21 depicts a linear fit of yellow average counts and loading densities. FIG. 22 depicts a histogram of various hand sheets containing red security particles; and FIG. 23 depicts a linear fit of red average counts and loading densities.

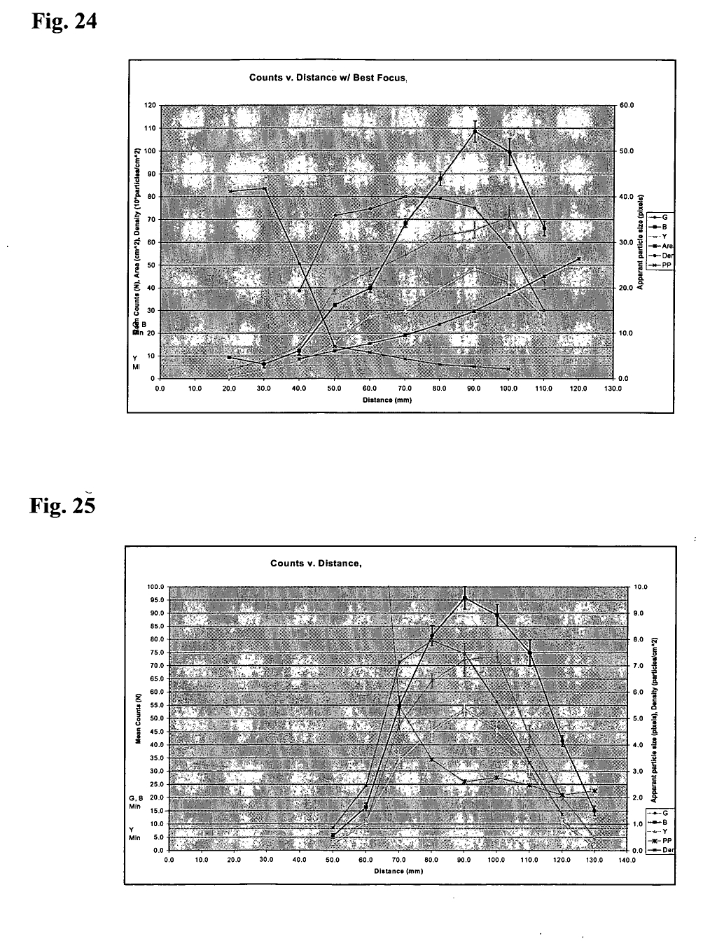

Testing was performed to optimize the focus distance to maximize counts without an coincident and excessive drop in flash intensity and brightness of the security particles 1150. The device 5 was set at various distances from the paper 200 a number of images 404 were collected. FIG. 24 provides a plot of counts versus distance. The total counts for all colors were divided by the area sampled to give a “density” metric. It was decided that the best fixed-focus distance would be where the counts were highest and the density was still maximized. It was determined that an optimal distance for the fixed-focus was approximately 8 cm for the particular combination of paper 200 and device 5.

After setting the fixed-focus to 8 cm, the device 5 was moved to other distances to determine the depth of focus. FIG. 25 shows that positive detection occurred for a depth of focus of nearly 6 cm and the density peaks appeared at approximately 8 cm (as expected).

Overprinting the security particles 1150 can make detection more difficult. Below are discussed the various types of overprinting and their respective effects.

Text overprinting in a standard size font and language structure typically covers about 10% of the surface area on a printed page. Based on empirical data, security particles 1150 that are totally overprinted with black text will not be counted. Particles 1150 that are partially obscured will exhibit reduced detectability. Overall, these effects should reduce counts of the particles 1150 on a printed document 200 by slightly more than the percentage or surface area covered by the text overprinting.

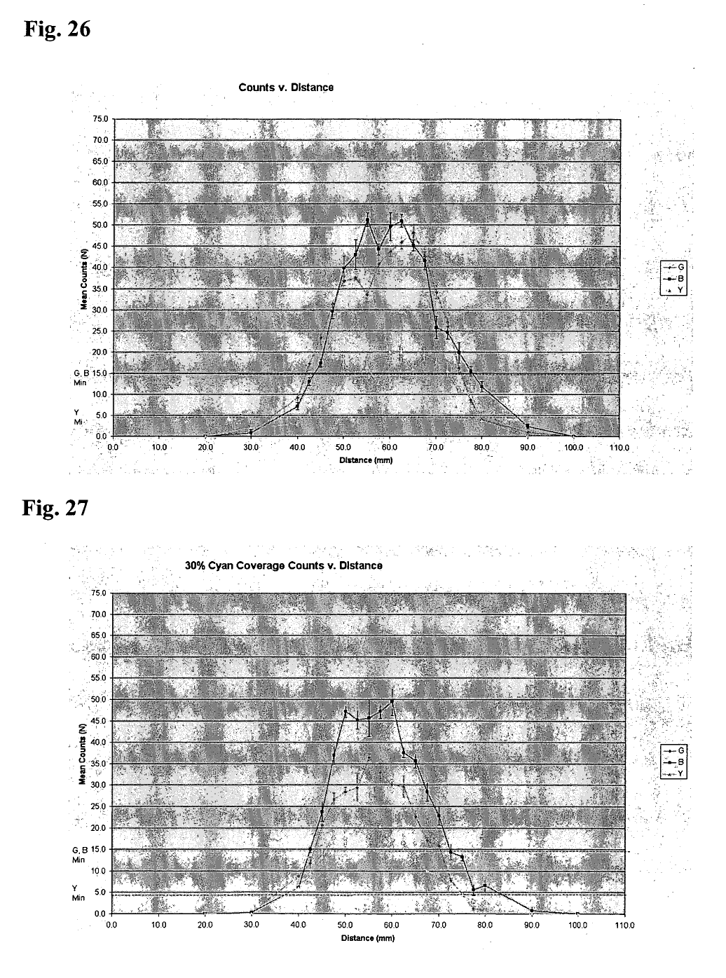

Overprinting with various colored inks can cause different effects. In various experiments, screen-printing was used to produce between about 10% and about 80% coverage of ink on a paper substrate 200. Various colors were tested including cyan, magenta, green and yellow. Results varied by the color. Preferably, no more than about 30% coverage is present on a substrate 200. FIGS. 26-30 present graphs depicting the effect of overprinting on readout.

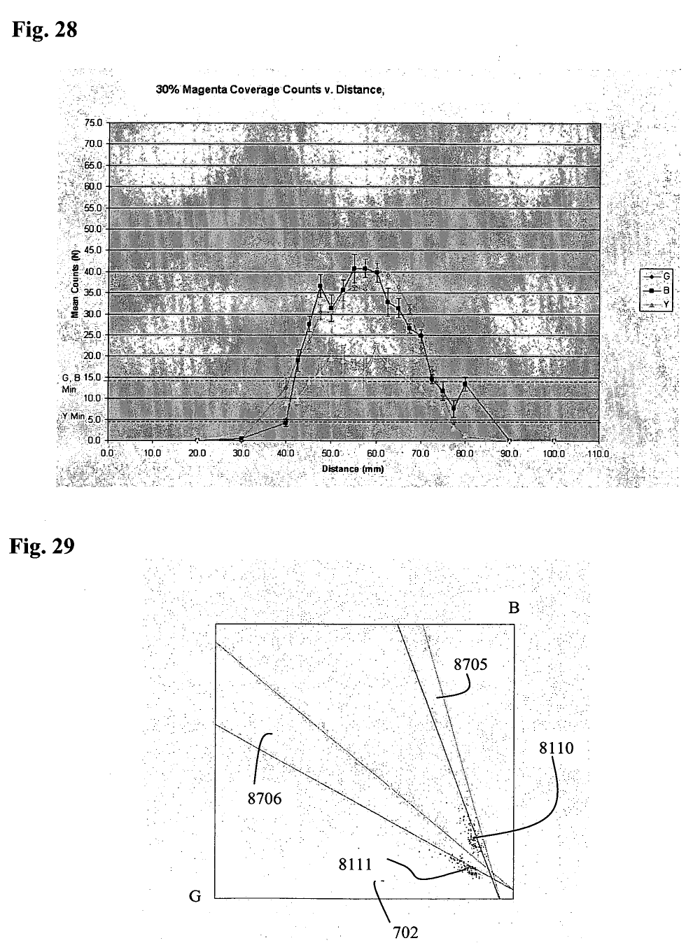

FIG. 26 depicts readout of GBY security particles without any overprint, on 24 pound paper; FIG. 27 depicts readout of GBY security particles with 30% overprint of cyan ink, on 24 pound paper; and FIG. 28 depicts readout of GBY security particles with 30% overprint of magenta ink, on 24 pound paper.

Cyan, magenta and green overprint interfered little with detection at the default read distance. At 80% overprint, total counts were reduced by about half, but positive reads were still easily achieved. A shrinking in the read depth occurred for greater percentages of overprint. However, yellow overprint substantially interfered with detection of the particles 1150. At 30% overprint, total counts were reduced to levels below the read threshold.

FIG. 29 depicts green and blue particles 8111, 8110 and respective valid color areas 8705, 8706 in the GB plane 702 with a 30% yellow overprint. FIG. 29 shows how the yellow overprint shifts most of the particles 1150 out of their respective valid color areas 8705, 8706. Other experimentation revealed that ultra-violet inks can greatly perturb the ability to detect some embodiments of the security particles 1150.

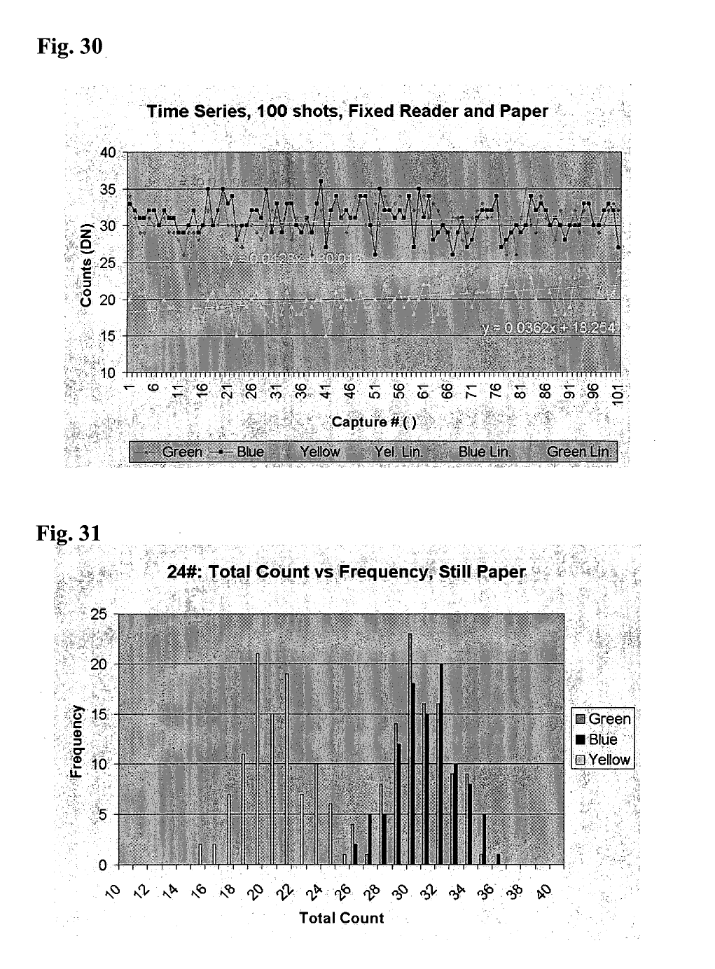

Further testing was performed to determine the variability in both the device 5 and the subject paper 200. In one embodiment, the device 5 was positioned above 24 pound paper 200 containing G, B and Y colored particles 1150, and operated so as to generate 100 successive images 404. Neither the device 5 nor the paper 200 was moved during the test. Keeping illumination and geometry constant achieved a good representation of the variability in the device 5. FIGS. 30-31 provide graphical illustrations of the time series and a histogram of the data.

Referring to FIGS. 30-31, the average counts and standard deviations for the GBY colors were 30.6, 31.0, 20.1 and 2.0, 2.2, 2.2, respectively. This indicates a typical standard deviation of 2 counts for each color regardless of the count level.

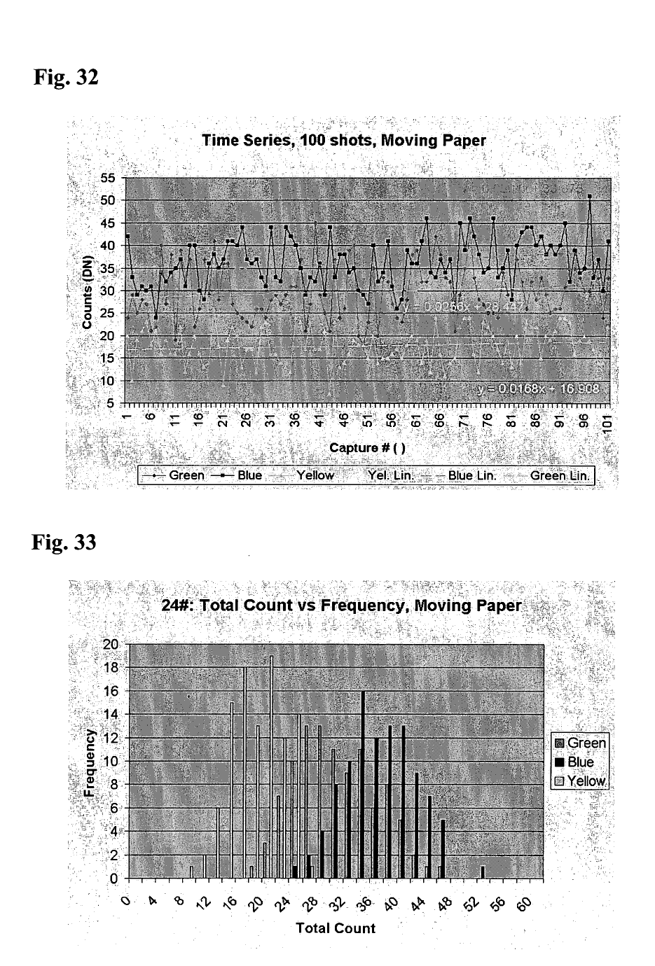

In a similar evaluation, the device 5 was positioned above 24 pound paper containing GBY particles, and operated so as to generate 1000 successive images 404. In this test, the paper 200 was moved around in random patterns. An attempt was made to evaluate as much of the paper as possible without shooting off the edge. It is considered that moving the paper and keeping illumination constant achieved a good representation of the combined variability in the device 5 and the paper 200. FIGS. 32-33 depicts the data for the time series and a histogram of the data.

In this test, the average counts and standard deviations for the GBY colors were 29.8, 36.2, 17.8 and 6.0, 5.4, 4.0, respectively. Combining these numbers with the fixed data, it can be seen that the displacements of the particles 1150 in the paper 200 have standard deviations of roughly 4.0, 3.2 and 1.8, respectively, for the GBY colors.

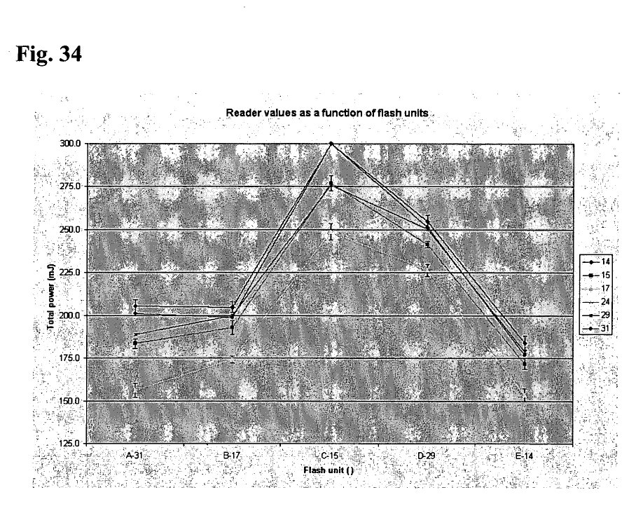

In yet a further test, flash intensity was evaluated. Differences in apparent flash brightness were observed between six separate devices 5. A testing regime was set up to determine differences in flash intensity between a matrix of five flash units 30 and the six separate devices 5. Differences were observed at first in total flash energy. After updating the flash control software, more tests were undertaken. Those results are presented in FIG. 34.

FIG. 34 shows that the range of variability between individual flash units 30 in a single device 5 can be significant. Among other things, this variability is a result of the differences inherent in the flash tubes. FIG. 34 also shows that variation in flash performance can be attributed to the device 5. However, it is considered that variability, such as demonstrated in regard to flash performance, can be easily accounted for through various calibration techniques.

While described in the context of the hand-held, portable color measurement device 5, it should be appreciated that certain aspects of these teachings may be practiced with systems that are not portable or hand-held, or that are intended to be operated in a fixed location, or that are integrated into larger systems, such as spectrophotometers. In some applications, the device 5 could be installed within or with another type of hand-held device, such as a portable data terminal or a voice communication device.

In some embodiments, appropriate hardware and/or software are combined with various commercially available products, such as a palm-top device equipped with an imaging system to provide for a device 5 as disclosed herein.

Further, by example, the device 5 could be combined with a laptop computer, wherein the laptop computer assembles data in a database as a result of measurements. This embodiment may be helpful in the situation where law enforcement officials need to collect forensic information indicating an origin of counterfeit documents.

Note as well that the transmitted data derived from color measurement may be combined with other data that is automatically generated or that is manually entered into the device 5 using the keyboard 50.

Note as well that the device 5 can operate in conjunction with other devices which may be connected in a network. For example, the device 5 could be used with another device 5, both of which are connected to a laptop computer. In this configuration, the user could simultaneously produce color coordinates for a color target 200, using multiple color classification algorithms 18A. In another embodiment, the use of a microphone 25 could facilitate note taking in field environments.

A result is that rapid evaluations of security features, such as particles 1150, as disclosed herein are made possible, with the hand held device 5 that produces digital color data. This device 5 is capable of supporting a variety of information and communication protocols, which lend versatility to the device 5 and the applications for which it may be used. The device 5 may operate as an integrated and stand alone unit, or as a part of a system and therefore provide data to a remote user.

Thus, it should be appreciated that while these teachings have been particularly shown and described with respect to preferred embodiments thereof, it will be understood by those skilled in the art that changes in form and details may be made therein without departing from the scope and spirit of the invention.

1. A method for authentication of a substrate, the method comprising:
generating a color image of the substrate, the color image comprising pixels;
identifying at least one region of authentically colored pixels by comparing the color of at least a portion of the pixels to at least one predetermined color in a first comparison test;
determining at least one morphological aspect for the identified at least one region by operation of a morphological determination algorithm;
comparing the at least one morphological aspect of the identified at least one region to at least one predetermined morphological value in a second comparison test; and,
authenticating the substrate if the first comparison test and the second comparison test are successful.

2. The method as in claim 1, wherein the morphological determining algorithm comprises counting pixels along a perimeter of the at least one region.

3. The method as in claim 2, wherein counting pixels comprises counting contiguous pixels where an outer edge of the region of authentically colored pixels appears.

4. The method as in claim 2, wherein counting pixels along the perimeter further comprises accounting for edge effects along the perimeter.

5. The method as in claim 1, wherein the at least one morphological aspect comprises at least one of a shape, a size, a thickening, a direction, and a thinning of the at least one region.

6. The method as in claim 1, wherein the morphological determination algorithm comprises an algorithm for performing one of a connected components analysis, a thickening analysis, a directional analysis and a hit-or-miss transform analysis.

7. The method as in claim 1, further comprising:
counting a number of occurrences of acceptable results and unacceptable results for the first comparison test and the second comparison test; and
comparing the number of these occurrences to a predetermined value for success to determine success.

8. The method as in claim 7, wherein the predetermined value for success comprises: a threshold against false positive detection.

9. The method as in claim 1, further comprising:
tracking a number of unacceptable results for at least one of the first comparison test and the second comparison test and decertifying at least one of the predetermined color and the morphological aspect where the number of unacceptable results is above a predetermined threshold.

10. The method as in claim 1, wherein the identifying at least one region further comprises:
identifying pixels in the at least a portion of the pixels that comprise a gray level that exceeds a predetermined value.

11. The method as in claim 1, wherein comparing the color of at least a portion of the pixels further comprises:
determining a set of color coordinates for pixels in the at least a portion of the pixels; and
comparing the color coordinates to a set of boundaries for a valid color area.

12. The method as in claim 1, wherein authenticating the substrate comprises identifying at least one code.

13. The method as in claim 12, wherein identifying at least one code comprises:
tracking a number of acceptable results for at least one of the first comparision test and the second comparision test and certifying at least one of the predetermined color and the morphological aspect where the number of acceptable results is above a predetermined threshold; and
validating a presence of the code once each predetermined color and each morphological aspect comprised in the code are certified.

14. The method as in claim 1, wherein at least one of the predetermined color and the predetermined morphological value is at least one of manually determined, automatically determined and generated from an image of at least one authentic substrate.

15. A system for authentication of a substrate, the system comprising:
a source of authentication data comprising authentic color information and morphological aspect information, the authentication data derived from at least one color image of at least one authentic substrate comprising at least one set of security features, the morphological aspect information of the at least one set of security features of the authentic substrate is determined by operation of a morphological determination algorithm;
an imaging sub-system for producing a color image of the substrate that is to be authenticated, the substrate that is to be authenticated comprises at least one set of security features; and
a processor coupled to the source of authentication data and coupled to the imaging sub-system, the processor adapted for comparing color information and morphological aspect information of the at least one set of security features of the color image of the substrate that is to be authenticated to the authentication data and determining the authenticity of the substrate.

16. The system as in claim 15, wherein the morphological aspect information comprises a number of pixels derived from the at least one color image of at least one authentic substrate.

17. The system as in claim 15, wherein the morphological aspect information comprises at least one of shape information, size information, thickening information, thinning information, and connected components information.

18. The system as in claim 15, wherein the authentication data comprises at least one code.

19. The system as in claim 15, wherein the imaging sub-system comprises a CCD array and a plurality of color filters.

20. The system as in claim 19, wherein the plurality of color filters comprises a Bayer mosaic pattern.

21. The system as in claim 15, wherein the imaging sub-system comprises an array of RGB CCD photo detectors.

22. A method for providing calibration data for a system for authenticating a substrate, the method comprising:
selecting at least one authentic substrate comprising at least one set of security features;
generating a color image of the at least one authentic substrate;
analyzing the color image to determine color data for the at least one set of security features and storing the color data as calibration data; and,
analyzing the color image to determine morphological aspect data for the at least one set of security features by operation of a morphological determining algorithm and storing the morphological aspect data as calibration data.

23. The method as in claim 22, wherein the morphological determining algorithm comprises an algorithm for performing one of: counting pixels about a perimeter, a connected components analysis, a thickening analysis, a directional analysis, a thinning analysis and a hit-or-miss transform analysis.

24. The method as in claim 22, wherein the morphological aspect data comprises data regarding at least one of a shape and a size.

25. The method as in 22, wherein the calibration data comprises a statistical analysis of at least one of the color data and the morphological aspect data.

26. The method as in 25, wherein the statistical analysis comprises at least one of an average, a standard deviation, and a confidence level for the at least one set of security features.

27. A computer program stored on computer readable media, the computer program comprising instructions for operation of a device adapted for authentication of a substrate by:
generating a color image of the substrate, the color image comprising pixels;
identifying at least one region of authentically colored pixels by comparing the color of at least a portion of the pixels to at least one predetermined color in a first comparison test;
determining at least one morphological aspect for the at least one region by operation of a morphological determining algorithm;
comparing the at least one morphological aspect for the at least one region to at least one predetermined morphological value in a second comparison test; and,
authenticating the substrate if the first comparison test and the second comparison test are successful.

28. The computer program as in claim 27 wherein the morphological determining algorithm comprises one of: counting pixels about a perimeter, a connected components analysis, a thickening analysis, a thinning analysis and a hit-or-miss transform analysis.

29. The computer program as in claim 28, wherein comparing the color of at least a portion of the pixels further comprises:
determining a set of color coordinates for pixels in the at least a portion of the pixels; and,
comparing the color coordinates to a set of boundaries for a valid color area.

30. A method for authentication of a document, the method comprising:
generating a color image of the document, the color image comprising pixels, the document comprising at least one security feature comprising at least one of security particles, threads, ribbons, discs, planchets, fluorescent printing and fibers;
comparing the color of at least a portion of the pixels of an image of the at least one security feature to at least one predetermined color in a first comparision test;
determining at least one morphological aspect for the at least a portion of the pixels of the at least one security feature by operation of a morphological determination algorithm, the at least one morphological aspect comprising at least one of shape information, size information, thickening information, thinning information and connected components information;
comparing the at least one morphological aspect of the at least a portion of the pixels of the at least one security feature to at least one predetermined morphological value in a second comparison test; and
authenticating the document if the first comparison test and the second comparison test are successful.

31. A system for authentication of a document, the system comprising:
a source of authentication data comprising authentic color information and morphological aspect information, the authentication data derived from at least one color image of at least one authentic document comprising at least one set of security features, the morphological aspect information of the at least one set of security features of the authentic document is determined by operation of a morphological determination algorithm, the morphological aspect information of the authentic document comprises at least one of shape information, size information, thickening information, thinning information and connected components information, the security features of the authentic document comprising at least one of security particles, threads, ribbons, discs, planchets, fluorescent printing and fibers;
an imaging sub-system for producing a color image of the substrate that is to be authenticated, the document that is to be authenticated comprises at least one set of security features, the at least one set of security features of the authentic document comprising at least one of security particles, threads, ribbons, discs, planchets, fluorescent printing and fibers; and
a processor coupled to the source of authentication data and coupled to the imaging sub-system, the processor adapted for comparing color information and morphological aspect information of the at least one set of security features of the color image of the document that is to be authenticated to the authentication data and determining the authenticity of the document, the morphological aspect information of the at least one set of security features of the color image of the document that is to be authenticated comprises at least one of shape information, size information, thickening information, thinning information and connected components information.
